(19) United States
(12) Patent Application Publication
(10) Pub. No.: US 2016/0117774 A1
(43) Pub. Date: Apr. 28, 2016

(54) ENVIRONMENT, SOCIAL AND GOVERNANCE RATING SYSTEM

(71) Applicant: ENSOGO Analytics LLC, Salem, OR (US)

(72) Inventor: Mark Eric Bateman, Salem, OR (US)

(73) Assignee: ENSOGO Analytics LLC, Salem, OR (US)

(21) Appl. No.: 14/918,494

(22) Filed: Oct. 20, 2015

Related U.S. Application Data
(60) Provisional application No. 62/068,289, filed on Oct. 24, 2014.

(51) Int. Cl. G06Q 40/06

(52) U.S. Cl. CPC G06Q 40/06

(57) ABSTRACT

A scoring system scores companies based on environment, social, and governance (ESG) data. The scoring system identifies the ESG data for the companies within a group of companies. The scoring system calculates individual company ESG scores from the ESG data and weights the company ESG scores based on proportions of the group of companies. The scoring system then generates a group ESG score based on the weighted company ESG scores for the group of companies. The rating system may calculate the company ESG scores based on different data categories, such as environmental related data, social related data, and governance related data.

This application claims priority to provisional application U.S. Ser. No. 62/068,289 filed Oct. 24, 2014 which is incorporated by reference in its entirety.

### BACKGROUND

Mutual funds and fund indexes identify monetary performance for different groups of companies. However, consumers have no way to determine the performance of the companies in the funds and indexes in other categories, such as performance related to environmental issues.

### BRIEF DESCRIPTION OF THE DRAWINGS

FIG. 1A shows how a weighted average score is displayed.

FIG. 1B shows how sub components of an overall score are displayed.

FIG. 1C shows how weighted holdings attributes are displayed.

FIG. 1D shows how a percentile comparison is displayed.

FIG. 1E shows an overall ESG process.

FIG. 2 shows how an overall ESG Score is generated.

FIG. 3 shows a CEO Compensation Category Score.

FIG. 4 shows a Climate Change Category Flowchart.

FIG. 5 shows a Community Category Scoring.

FIG. 6 shows an Environmental Performance Score Calculation.

FIG. 7 shows an Environmental Category Calculation.

FIG. 8 shows a Governance Category Score.

FIG. 9 shows a Human Rights and Labor Category Score.

FIG. 10 shows a computer system that calculates the ESG scores.

### DETAILED DESCRIPTION

A rating system is based on environment, social, and governance (ESG) data. The description below describes example processes for generating mutual fund ESG ratings and exchange traded fund (EFT) ratings. However, it should be understood that ESG ratings may be calculated for individual companies or calculated for any other entity independently of any mutual fund ESG rating or ETF ESG rating and independently of ESG ratings calculated for other companies. For example, a person may request an ESG rating on a single company purely for research or informational purposes independently of any security or financial product offering. It should also be understood that the ESG processes described below are only examples and ESG rating may be generated for any combination of the environmental, social, and/or governance data described below or any other information similar types of data.

### DEFINITIONS

Mutual fund: In one example, a mutual fund is a pool of money used by investors to invest in stocks, bonds, short-term money market instruments, or other public securities. Mutual funds also may refer to the common name for an open-end investment company.
ESG Data: ESG stands for “environmental, social, and governance”. ESG data comprises corporate (or other entity) behavior, policy, and performance data and is accumulated by private entities, government regulators, and non-profits. In some situations ESG may not include financial performance metrics. However, certain financial accounting data may relate to ESG issues and therefore qualify as ESG data. ESG information may include things like pollution, human rights, labor data or board operating structure. ESG may also include industry involvement attributes that are of interest to investors, often referred to as values-based investors. Examples of these industries might include alcohol, tobacco, nuclear power, etc.
Security: A security may refer to any note, stock, treasury stock, security future, security-based swap, bond, debenture, evidence of indebtedness, certificate of interest or participation in any profit-sharing agreement, collateral-trust certificate, preorganization certificate or subscription, transferable share, investment contract, voting-trust certificate, certificate of deposit for a security, fractional undivided interest in oil, gas, or other mineral rights, any put, call, straddle, option, or privilege or any security, certificate of deposit, or group or index of securities (including any interest therein or based on the value thereof), or any put, call, straddle, option, or privilege entered into on a national securities exchange relating to foreign currency, or, in general, any interest or instrument commonly known as a “security”, or any certificate of interest or participation in, temporary or interim certificate for, receipt for, guarantee of, or warrant or right to subscribe to or purchase, any of the foregoing, or the like, or any combination thereof.
Security identifier: A number of different identifiers are used for identifying securities for market trading purposes. These identifiers commonly include CUSIP (an identifier created by the Committee on Uniform Securities Identification Procedures), ticker, SEDOL (Stock Exchange Daily List), ISIN (International Securities Identification Number). The security identifier positively links two sets of data such that despite minor variations in the names used to label securities, the same security will be matched appropriately across data sets.
Exchange Traded Funds: a security that tracks a basket of assets, often an index of stocks.

### Section 1: Generating Mutual Fund ESG Scores

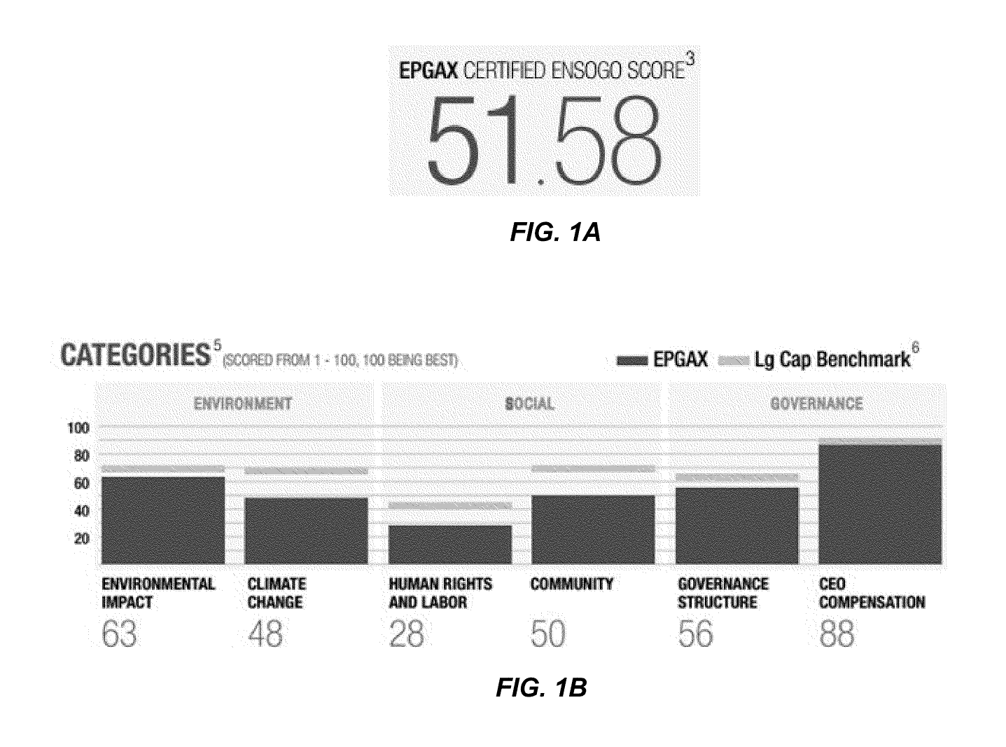

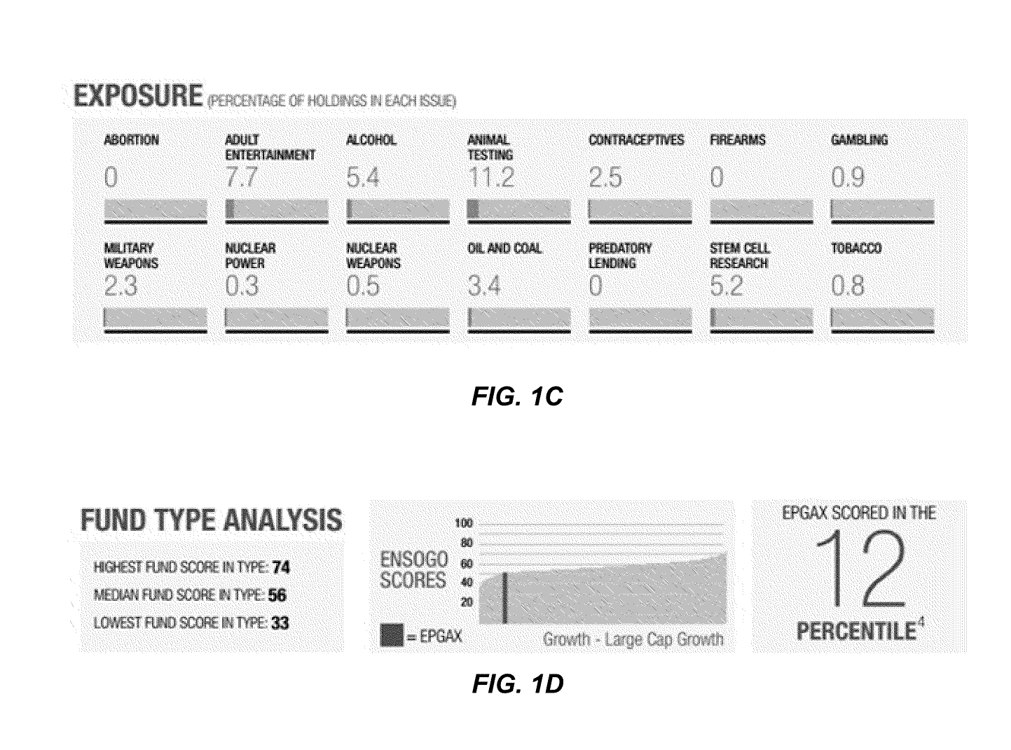

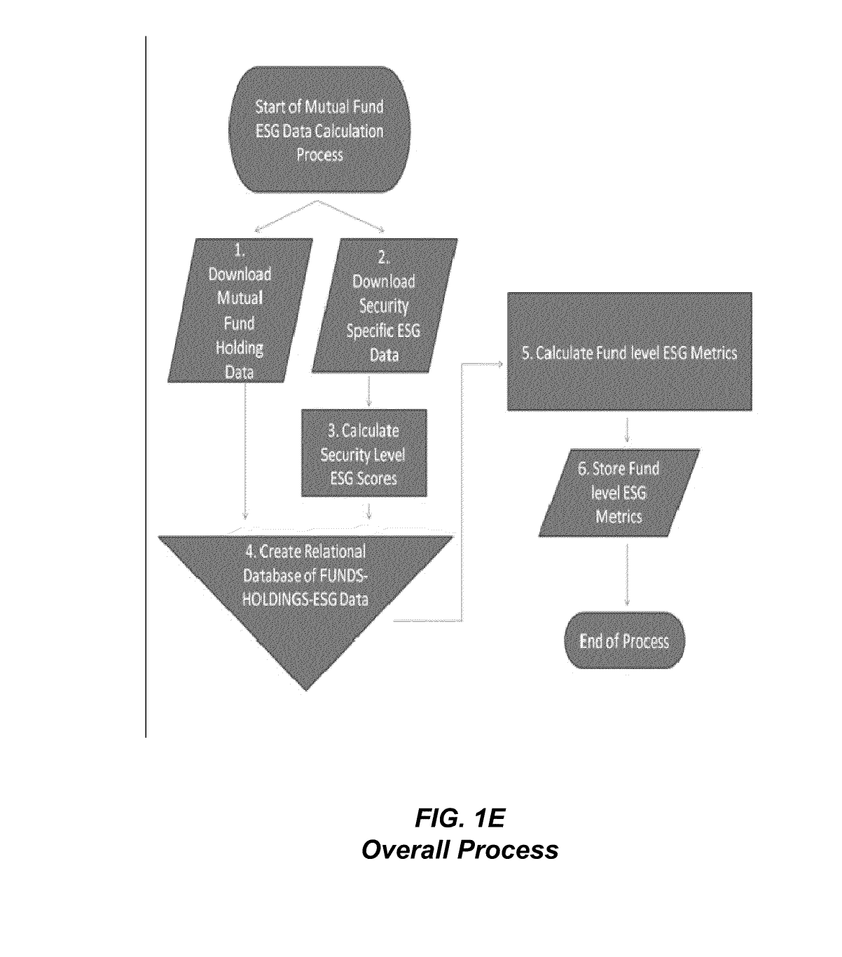

1. This section outlines an overall process of generating ESG Ratings of Mutual Funds. FIG. 1E demonstrates the process which uses two sets of data as inputs to then generate a series of ESG scores for each mutual fund. The following numeric sequence in this section correspond to the numbers included in FIG. 1E. Download the mutual fund holdings data which includes appropriate security identifiers and weightings of the securities (percentage of each security) within each mutual fund.
2. Download the ESG data corresponding to the same security identifiers as well as specific ESG data and attributes. ESG data may come from one or more sources. These may be data aggregators like IW Financial, MSCI or Bloomberg, or primary source material like company websites, company sustainability reports, US Environmental Protection Agency data sets, etc. Each ESG data set includes company specific identifiers tied to specific ESG data. ESG data may include numeric, true/false, standard categorizations, pre-calculated ratings, or any other data type that would lend itself to statistical summary. ESG data may be objective and factual or subjective. There may be dozens or hundreds of data elements within an ESG Data Set.
   a. Factual data would include things like pounds of CO2 emissions or CEO Salary.
   b. Subjective data would include things like whether an environmental policy is poor, fair, good, or excellent.
      FIG. 1E steps #3, #4, #5 constitute the processing for generating mutual fund-level ESG metrics.
3. The ESG Data Set downloaded in #2 may be combined in a number of ways to generate different Security Level ESG Scores. A Security (most frequently a company or bond, but see Definition above for other examples) can be scored on ESG issues like environmental performance, human rights disclosure, etc. and/or an aggregation of such category scores into an overall ESG score. Each of these examples would include one or more data elements from the ESG Data Set to calculate the score for that issue. (The latter portion of this patent application outlines a specific scoring algorithm.)
4. Based on security identifiers, the two data sets will be related to one another in a relational database. For each mutual fund, this creates a set of relevant ESG security level evaluations—the holdings of the mutual fund with their corresponding ESG data. This constitutes a relational database linking mutual funds to securities to ESG scores and attributes (hereafter FUND-HOLDINGS-ESG Data).
5. Operation #5 generates statistical summaries. The statistical summaries are based on the Security Level ESG Scores created in operation #3 and summarizes the mutual funds data downloaded in operation #1 and related to the ESG Data in operation #4. The following are examples of statistical summaries, but this is not a comprehensive list:
   a. Mean Score (e.g. the average CO2 emissions for companies held by a fund)
   b. Median Score (e.g. the median percentage of a fund invested in tobacco companies)
   c. Weighted Average Score (weighted based on the percentage of a fund that each individual security represents)
      i. e.g. the weighted average ESG Score: 61.5
      1. Walmart (weighting 25%; ESG Score 50)
      2. Intel (weighting 50%; ESG Score 75)
      3. ExxonMobil (weighting 20%; ESG Score 40)
      4. IBM (weighting 5%; ESG Score 70)
d. Numeric count of a certain attribute. For instance, if an individual security is “true” for involvement in the tobacco industry, what number of securities held within the mutual fund that are “true” for the same involvement.
e. Weight of holdings “true” for a certain attribute.
   i. E.g. the weight of holdings true for Tobacco Retail Sales: 45%
      1. Walmart (weighting 25%; Tobacco Retail Sales=True)
      2. Intel (weighting 50%; Tobacco Retail Sales=False)
      3. ExxonMobil (weighting 20%; Tobacco Retail Sales=True)
      4. IBM (weighting 5%; Tobacco Retail Sales=False)
   f. Percentile rank. Within a group of peer funds (i.e. funds of the same fund investment type as defined by industry . . . large cap, small cap, etc.), ESG Scores will be rank ordered and a percentile calculated determining that a given fund is better than X percent of the other funds in the peer group.
   g. Peer Group Median Score (based on the count of peers). Within a group of peer funds, determine the median score.
   h. Peer Group Asset Median Score. Within a group of peer funds, determine the median score such that half the total invested assets of the group score better, and half the total invested assets score worse.
6. Once the mutual fund level scores, attributes, and other statistical information is calculated, this information is stored for future retrieval, processing, display, or other use. These scores may be displayed in a report. The following are such examples:
   a. Weighted Average Score: FIG. 1A shows a graphic of how a weighted average score (5c above) for a fund could be displayed
   b. Categories: FIG. 1B shows how sub components of an overall score could be displayed as categories. In this case, they are also weighted average scores (5c above)
   c. Fund Holding Attributes: FIG. 1C shows how weighted holdings attributes (5e above) could be displayed.
   d. Peer Comparison: FIG. 1D shows how a percentile comparison (5f above) could be displayed.

### Section 2: ESG Scoring Algorithm

This section outlines an ESG scoring algorithm comprised of six sub categories. Following is a description of the aggregation of those categories into a single score and then the method for calculating the category scores. Section 2 provides a detailed description of Boxes 2 and 3 from FIG. 1E.

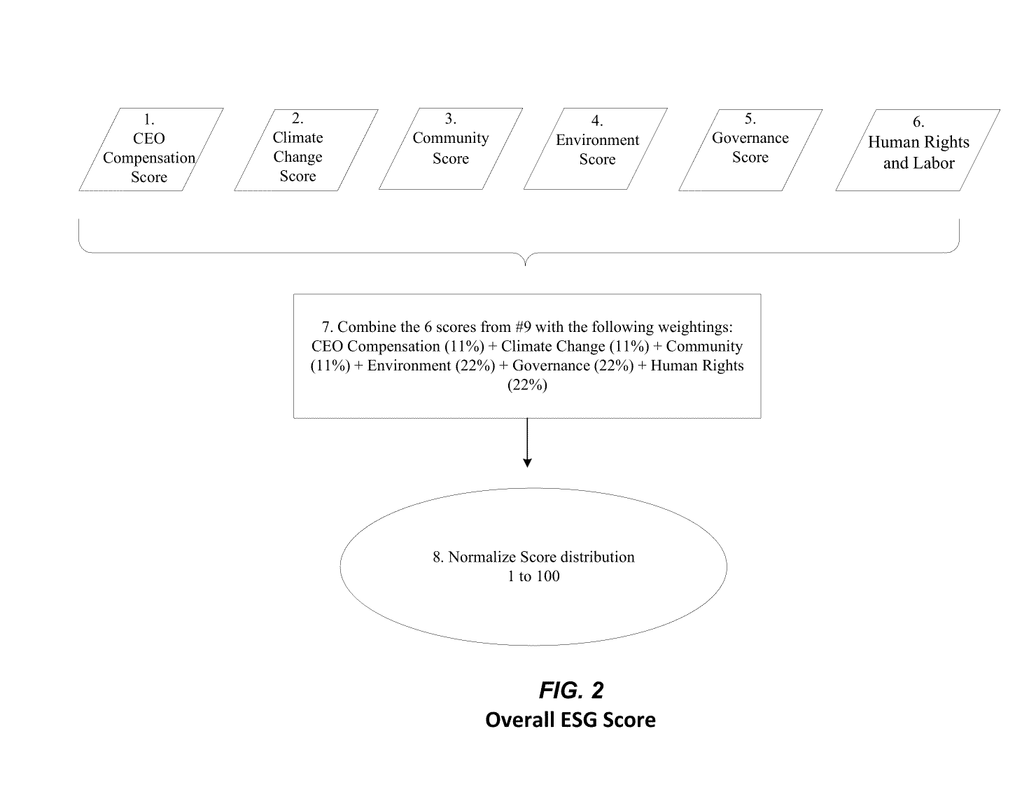

The combination into a single score is demonstrated in FIG. 2. The outline numbers that follow in this section correspond to the numbers included in FIG. 2.
1. Calculate the CEO Compensation Category Score as described in Section 2.2
2. Calculate the Climate Change Category Score as described in Section 2.3
3. Calculate the Community Category Score as described in Section 2.4
4. Calculate the Environment Category Score as described in Section 2.5
5. Calculate the Governance Category Score as described in Section 2.6
6. Calculate the Human Rights and Labor Category Score as described in Section 2.7
7. Combine these 6 category scores using the following formula

([CEO Compensation Category Score]*0.11)+([Climate Change Category Score]*0.11)+([Community Category Score]*0.11)+([Environment Category Score]*0.22)+([Governance Category Score]*0.22)+([Human Rights and Labor Category Score]*0.22)
8. Once the Combined Scores (#7 FIG. 2) have been calculated, distribute these values on a scale of 1 to 100 using the following formula for each company in the data set.

1+(([Combined Scores]−[Minimum Combined Scores in the dataset])*(100−1)/([Maximum Combined Scores in the dataset]−[Minimum Combined Scores in the dataset]))

Section 2.1: Notes regarding ESG Data and Calculations
In the following sections, references will be made to a variety of specific data used in calculating an ESG score. The following notes are intended to help the reader understand the nature of the data and calculations.
1. Data Sources: the process described in this document currently relies on ESG data provided by a third party vendor. This vendor provides the “raw” data in a machine readable format, which is then processed as described in this document. Because the source provides raw data, these data may be sourced from a variety of vendors and/or developed organically to feed directly into the ratings process.
   a. If developed organically, data would come from the following types of original sources. These are examples of types of sources and do not reflect all of the specific data sources:
      i. Data are read by human or machine on a document specific basis to populate an ESG database with the data elements used throughout Section 2 of this document.
         1. Company websites.
         2. Company financial filings (e.g. Form 10-K)
         3. Company sustainability reports
      ii. Comprehensive data sets are retrieved in machine readable format reflecting subcomponents of companies (e.g. facilities, subsidiaries, etc.). Once downloaded, computer systems and/or human effort attribute subcomponents to the ultimate parent company. Quantitative data are then aggregated to the same parent company level to populate an ESG database with data elements used throughout Section 2 of this document.
         1. Government data sets (e.g. U.S. Environmental Protection Agency Toxic Release Inventory, U.S. Department of Labor Strikes Database)
      iii. Non company data used as context or input for evaluations of companies. These data may be accessed by human or machine and populated into an ESG database with data elements used throughout Section 2 of this document.
         1. Non-governmental organization (NGO) or advocacy group information (e.g. Freedom House country ratings)
   2. Example Data Types:
      a. Attributes. Throughout this process, the reader will see reference to data points described as “attributes.” These data elements are individual “true/false” or “yes/no” data elements. These elements are formulated so that they are binary, there is no possibility of a “maybe.” The ratings systems described in this document relies on the provision of this binary data for these elements and therefore relies on the research vendor methodology to determine the binary value without ambiguity.
      b. Numeric data. Throughout the process demonstrated in this document, numeric data will be used. Numeric data may be positive or negative, integers or decimals.

### Section 2.2: CEO Compensation Category Score: Governance

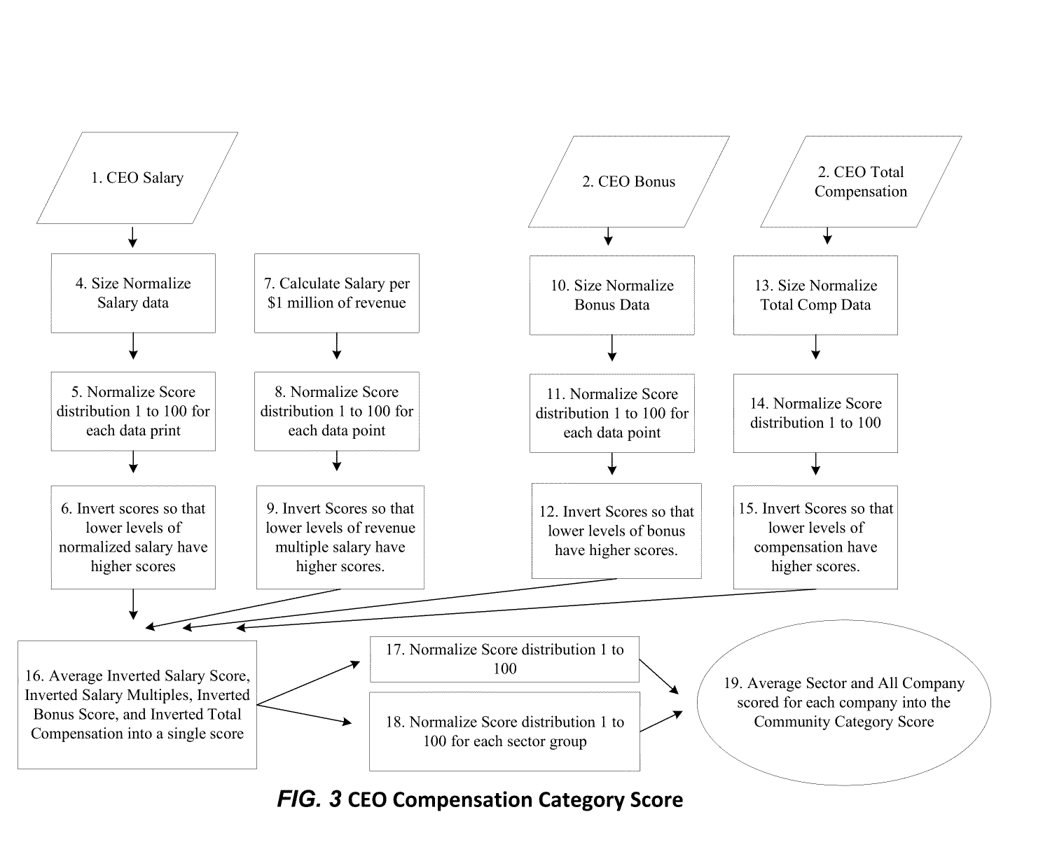

This section describes the calculation of a CEO Compensation Category Score which may be used independently, or as a component piece of a larger aggregate ESG score. This score includes a series of comparative performance calculations looking at salary, bonus, and total compensation.
The outline below documents the specific data and calculation steps for generating the CEO Compensation Category Score. For reference, FIG. 3 shows the flow of these steps. The numbers in the outline correspond with the flow chart elements in FIG. 3.
1. CEO Salary Data
   a. Total Salary Compensation for the company CEO for a recent year.
   b. Total Company Revenue for a recent year.
2. CEO Bonus Data
   a. Total Bonus pad to the company CEO for a recent year.
   b. Total Company Revenue for a recent year.
3. CEO Total Compensation
   a. Total Compensation includes salary, bonus payments, exercise of stock options, profit sharing, and any other compensation for a recent year.
   b. Total Company Revenue for a recent year.
4. Normalize Salary Data by dividing Total Salary by Total Company Revenue.
5. Once the Normalized Salary data have been calculated, distribute these values on a scale of 1 to 100 using the following formula for each company in the data set.

1+(([Normalize Salary]−[Minimum Normalize Salary in the dataset])*(100−1)/([Maximum Normalize Salary in the dataset]−[Minimum Normalize Salary in the dataset]))
6. Invert the Distributed Salary Score: 101−[Step #5]
7. Calculate Revenue Multiple using the following formula:

[Total Salary (Step 1)]/1,000,000
8. Once the Revenue Multiple Salary data have been calculated, distribute these values on a scale of 1 to 100 using the following formula for each company in the data set.

1+(([Revenue Multiple Salary]−[Minimum Revenue Multiple Salary in the dataset])*(100−1)/([Maximum Revenue Multiple Salary in the dataset]−[Minimum Revenue Multiple Salary in the dataset]))
9. Invert the Distributed Revenue Multiple Salary Score: 101−[Step #8]
10. Normalize Bonus Data by dividing Total Bonus by Total Company Revenue.
11. Once the Normalized Bonus data have been calculated, distribute these values on a scale of 1 to 100 using the following formula for each company in the data set.

1+(([Normalize Bonus]−[Minimum Normalize Bonus in the dataset])*(100−1)/([Maximum Normalize Bonus in the dataset]−[Minimum Normalize Bonus in the dataset]))
12. Invert the Distributed Bonus Score: 101-[Step #11]
13. Normalize Total Compensation Data by dividing Total Salary by Total Company Revenue.
14. Once the Normalized Total Compensation data have been calculated, distribute these values on a scale of 1 to 100 using the following formula for each company in the data set.

1+(([Normalize Total Compensation]−[Minimum Normalize Total Compensation in the dataset])*(100−1)/([Maximum Normalize Total Compensation in the dataset]−[Minimum Normalize Total Compensation in the dataset]))
15. Invert the Distributed Total Compensation Score: 101-[Step #14]
16. Average the Inverted Scores inputs using the following formula:

([Inverted Salary Score (Step 6)]+[Inverted Multiple Revenue Salary Score (Step 9)]+[Inverted Bonus Score (Step 12)]+[Inverted Total Compensation Score (Step 15)])/4
17. Once the Average Scores have been calculated, distribute these values on a scale of 1 to 100 using the following formula for each company in the data set.

1+(([Average]−[Minimum Average in the dataset])*(100−1)/([Maximum Average in the dataset]−[Minimum Average in the dataset]))
18. Calculate Sector Scores
   a. Each company in the dataset should be assigned to a unique industry or sector. For each sector in the universe, this system calculates a “sector score” which is a distribution from 1 to 100 of the Average Scores (Step 16) within each sector using the following formula:

1+(([Average Scores (Step 16)]−[Minimum Average Scores (Step 16) in the dataset])*(100−1)/([Maximum Average Scores (Step 16) in the dataset]−[Minimum Average Scores (Step 16) in the dataset]))
19. Calculate the Final CEO Compensation Scores using the following formula that combines the Distributed Combined CEO Comp Score (Step 17) with Sector Score (Step 18):

([Distributed Combined CEO Comp Score (Step 17)]+[Sector Score (Step 18)])/2

Section 2.3: Climate Change Category Score: Environment

This section describes the calculation of a Climate Change Category Score which may be used independently, or as a component piece of a larger aggregate ESG score. This score includes a series of attributes regarding individual companies, usually captured as true/false or yes/no data, as well as performance data elements the capture actual levels of emissions related to climate change.

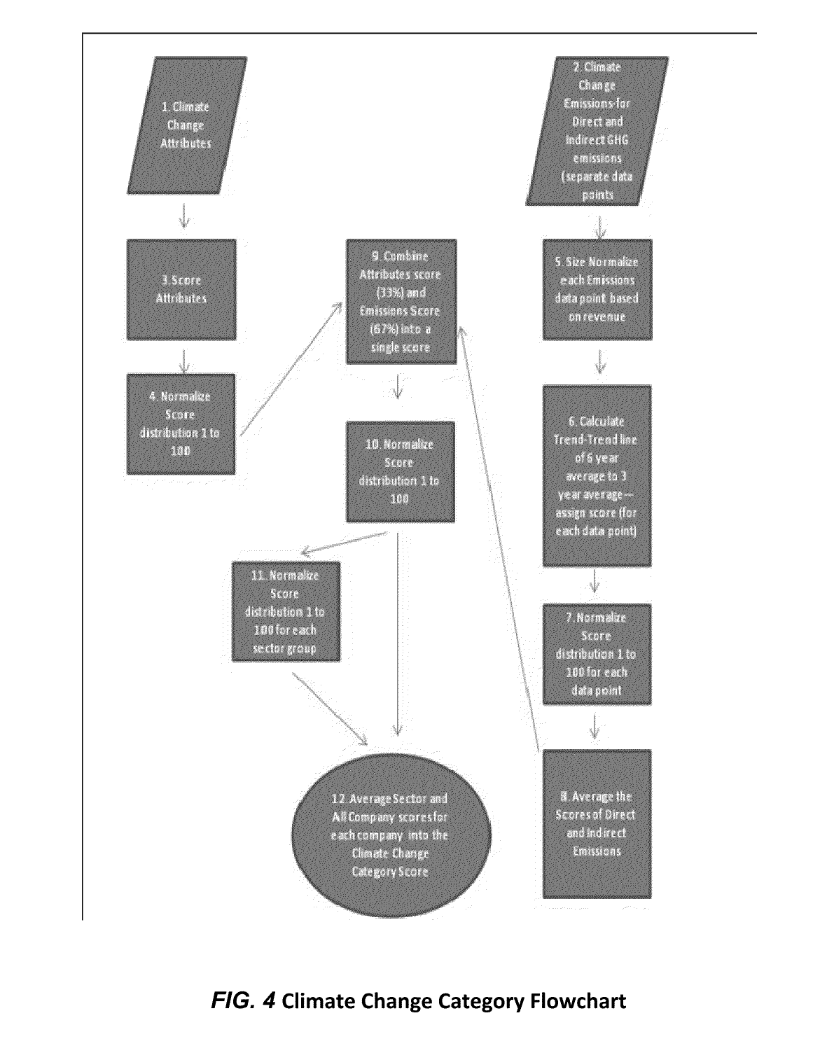

The outline below documents the specific data and calculation steps for generating the Climate Change Category Score. For reference, FIG. 4 shows the flow of these steps. The numbers in the outline correspond with the flow chart elements in the FIG. 4.
1. The data set of Climate Change Attributes includes:
   a. Part 1
      i. Does the company have any targets relating to Greenhouse gas (GHG) emissions?
      ii. Does the company disclose GHG emissions data on its website?
      iii. Does the company disclose GHG emissions data in its most recent Annual Report to Shareholders?
      iv. Does the company disclose a normalized total Indirect GHG emissions value?
      v. Does the company disclose its total Indirect GHG emissions?
      vi. Does the company disclose a normalized total Direct GHG emissions value?
      vii. Does the company disclose its total Direct GHG emissions?
   b. Part 2
      i. In reference to the company's total direct GHG emissions disclosure, how many consecutive years of data (including the most recent year) does the company disclose in its most recent report?
   c. Part 3
      i. Does the company disclose the percentage of total indirect GHG emissions that are balanced by the company's use of carbon sequestration?
      ii. Does the company disclose the percentage of total direct GHG emissions that are balanced by the company's use of carbon sequestration?
      iii. Does the company disclose the percentage of total indirect GHG emissions that are balanced by the company's purchase of carbon credits?
      iv. Does the company disclose the percentage of total direct GHG emissions that are balanced by the company's purchase of carbon credits?
      v. Does the company disclose the percentage of total indirect GHG emissions that are balanced by the company's use of carbon offsets?
      vi. Does the company disclose the percentage of total direct GHG emissions that are balanced by the company's use of carbon offsets?
   d. Part 4
      i. Do the same climate change policy standards apply to franchisees?
      ii. Does the company have a senior level company officer (vice-president or higher) designated as having the responsibility for oversight and/or implementation of the climate change policy?
      iii. Does the company indicate that this climate change policy supports a specific public policy goal?
      iv. Does the company disclose third party involvement in the development of this climate change policy?
      v. Does the company disclose the number of personnel involved in the implementation of this climate change policy?
      vi. Does the company have a department or staff dedicated to the implementation of this climate change policy?
      vii. Is the Board of Directors specifically mentioned as having responsibility for the climate change policy?
      viii. Does the climate change policy include a commitment to quantifiable targets or goals?
      ix. Does the climate change policy include a commitment to third-party auditing?
   e. Part 5
      i. Does the climate change policy include a commitment to public reporting?
      ii. Does the climate change policy include discrete, actionable elements from which programs can be derived and/or progress measured?
      iii. Does the climate change policy include a commitment to stakeholder involvement in the development of the policy, the implementation of the policy, and/or the evaluation of effective outcomes of the policy's implementation?
      iv. Is the climate change policy a global policy applying the same comprehensive standards to all company operations regardless of geographic location?
      v. Do the same standards found in the company's climate change policy apply to partners?
      vi. Do the same climate change policy standards apply to suppliers/vendors?
      vii. Is there a component of the climate change policy addressing partners? Included in this are business partnerships and joint venture participants.
      viii. Is there a component of the climate change policy addressing suppliers/vendors? Included in this are the company's direct supply chain, contracted sub-assemblers or custom fabricators, and providers of critical services (excluding fungible services).
      ix. Does the climate change policy/statement(s) specifically apply to all company operations?
   f. Part 6
      i. Does the company's climate change policy address: Water use/conservation?
      ii. Does the company's climate change policy address: Energy use/conservation?
      iii. Does the company's climate change policy address: Other emissions?
      iv. Does the company's climate change policy address: Greenhouse gases?
      v. Does the company have an enterprise level climate change policy?
2. The data set of Climate Change emissions includes
   a. Annual Pounds of GHG equivalent direct emissions for a recent 6 year period
   b. Annual Pounds of GHG equivalent indirect emissions for a recent 6 year period
   c. Annual company revenue for a recent 6 year period
3. Calculate a raw score based on the attributes data list in #2 above assigning points as follows:
   a. Part 1: For each of these questions, assign the points indicated when the answer is “yes” for a company.
      i. Does the company have any targets relating to GHG emissions? (3 points)
      ii. Does the company disclose GHG emissions data on its website? (1 point)
      iii. Does the company disclose GHG emissions data in its most recent Annual Report to Shareholders? (1 point)
      iv. Does the company disclose a normalized total Indirect GHG emissions value? (1 point)
      v. Does the company disclose its total Indirect GHG emissions? (3 points)
      vi. Does the company disclose a normalized total Direct GHG emissions value? (1 point)
      vii. Does the company disclose its total Direct GHG emissions? (3 points)
   b. Part 2. Assign points as described.
      i. In reference to the company's total direct GHG emissions disclosure, how many consecutive years of data (including the most recent year) does the company disclose in its most recent report? (0.5 points per year of disclosure, 5 points maximum)
   c. Part 3. If the answer to any of the following statements is “yes” for a company, then assign the company 2 points.
      i. Does the company disclose the percentage of total indirect GHG emissions that are balanced by the company's use of carbon sequestration?
      ii. Does the company disclose the percentage of total direct GHG emissions that are balanced by the company's use of carbon sequestration?
      iii. Does the company disclose the percentage of total indirect GHG emissions that are balanced by the company's purchase of carbon credits?
      iv. Does the company disclose the percentage of total direct GHG emissions that are balanced by the company's purchase of carbon credits?
      v. Does the company disclose the percentage of total indirect GHG emissions that are balanced by the company's use of carbon offsets?
      vi. Does the company disclose the percentage of total direct GHG emissions that are balanced by the company's use of carbon offsets?
   d. Part 4: For each of these questions, assign the points indicated when the answer is “yes” for a company.
      i. Do the same climate change policy standards apply to franchisees? (1 point)
      ii. Does the company have a senior level company officer (vice-president or higher) designated as having the responsibility for oversight and/or implementation of the climate change policy? (1 point)
      iii. Does the company indicate that this climate change policy supports a specific public policy goal? (1 point)
      iv. Does the company disclose third party involvement in the development of this climate change policy? (1 point)
      v. Does the company disclose the number of personnel involved in the implementation of this climate change policy? (1 point)
      vi. Does the company have a department or staff dedicated to the implementation of this climate change policy? (1 point)
      vii. Is the Board of Directors specifically mentioned as having responsibility for the climate change policy? (5 points)
      viii. Does the climate change policy include a commitment to quantifiable targets or goals? (3 points)
      ix. Does the climate change policy include a commitment to third-party auditing? (1 point)
   e. Part 5: For each of these questions, assign the points indicated when the answer is “yes” for a company.
      i. Does the climate change policy include a commitment to public reporting? (1 point)
      ii. Does the climate change policy include discrete, actionable elements from which programs can be derived and/or progress measured? (1 point)
      iii. Does the climate change policy include a commitment to stakeholder involvement in the development of the policy, the implementation of the policy, and/or the evaluation of effective outcomes of the policy's implementation? (1 point)
      iv. Is the climate change policy a global policy applying the same comprehensive standards to all company operations regardless of geographic location? (2 points)
      v. Do the same standards found in the company's climate change policy apply to partners? (1 point)
      vi. Do the same climate change policy standards apply to suppliers/vendors? (1 point)
      vii. Is there a component of the climate change policy addressing partners? Included in this are business partnerships and joint venture participants. (1 point)
      viii. Is there a component of the climate change policy addressing suppliers/vendors? Included in this are the company's direct supply chain, contracted sub-assemblers or custom fabricators, and providers of critical services (excluding fungible services). (1 point)
      ix. Does the climate change policy/statement(s) specifically apply to all company operations? (3 points)
   f. Part 6: For each of these questions, assign the points indicated when the answer is “yes” for a company.
      i. Does the company's climate change policy address: Water use/conservation? (1 point)
      ii. Does the company's climate change policy address: Energy use/conservation? (1 point)
      iii. Does the company's climate change policy address: Other emissions? (1 point)
      iv. Does the company's climate change policy address: Green house gases? (1 point)
      v. Does the company have an enterprise level climate change policy? (10 points)
4. Once the raw Attributes Score has been calculated for the entire universe of companies, distribute these scores on a scale of 1 to 100 using the following formula for each company in the data set:

1+(([Attributes Score]−[Minimum Attributes Score in the dataset])*(100−1)/([Maximum Attributes Score in the dataset]−[Minimum Attributes Score in the dataset]))
5. Size normalize each GHG emissions datapoint
   a. For each company, divide each year's Direct GHG emissions by the total revenue for that year.
   b. For each company, divide each year's Indirect GHG emissions by the total revenue for that year.
6. Calculate GHG emissions Trend line
   a. Direct GHG Emissions
      i. Calculate the average revenue normalized Direct GHG emissions for the recent 6 years available in the dataset.
      ii. Calculate the average revenue normalized Direct GHG emissions for the recent 3 years available in the dataset.
      iii. Calculate “6 year percentage” for each company as follows:

[6 year average]/[maximum 6 year average from the dataset]
iv. Calculate the Trend Line using the following formula: ([3 year average]−[6 year average])/[6 year average]
v. Assign Trend Line Scores as follows:
   1. If the Trend Line is negative (less than 0), “trends line temp score” 3
   2. If the Trend Line is greater than 1, “trends line temp score” 1
   3. If the Trend Line is less than 1 and greater than 0, then assign “trends line temp score” equal to the trend line calculation
   4. Calculate Trend Line Score using the following formula

1−(2*([6 year percentage]−[trend line temp score])
b. Indirect GHG Emissions
   i. Calculate the average revenue normalized Indirect GHG emissions for the recent 6 years available in the dataset.
   ii. Calculate the average revenue normalized Indirect GHG emissions for the recent 3 years available in the dataset.
   iii. Calculate “6 year percentage” for each company as follows:

[6 year average]/[maximum 6 year average from the dataset]
iv. Calculate the Trend Line using the following formula: ([3 year average]−[6 year average])/[6 year average]
v. Assign Trend Line Scores as follows:
   1. If the Trend Line is negative (less than 0), “trends line temp score” 3
   2. If the Trend Line is greater than 1, “trends line temp score” 1
   3. If the Trend Line is less than 1 and greater than 0, then assign “trends line temp score” equal to the trend line calculation
   4. Calculate Trend Line Score using the following formula

1−(2*([6 year percentage]−[trend line temp score])
7. Once the GHG Trend Line Scores have been calculated for the entire universe of companies, distribute these scores on a scale of 1 to 100 using the following formula for each company in the data set.
   a. Use the following formula to distribute the Direct GHG Emissions Trend Line Score:

1+(([Direct GHG Emissions Trend Line Score]−[Minimum Direct GHG Emissions Trend Line Score in the dataset])*(100−1)/([Maximum Direct GHG Emissions Trend Line Score in the dataset]−[Minimum Direct GHG Emissions Trend Line Score in the dataset]))
b. Use the following formula to distribute the Indirect GHG Emissions Trend Line Score:

1+(([Indirect GHG Emissions Trend Line Score]−[Minimum Indirect GHG Emissions Trend Line Score in the dataset])*(100−1)/([Maximum Indirect GHG Emissions Trend Line Score in the dataset]−[Minimum Indirect GHG Emissions Trend Line Score in the dataset]))
8. Calculate “GHG Emissions Score” for each company, average the scores generated in step 7 for Direct and Indirect GHG emissions using the following formula:

([Direct GHG Score (Step 7a)]+[Indirect GHG Score (Step 7b)])/2
9. Calculate “Combined Climate Change Scores” for each company, combine the Attributes Score (Step 4) with the GHG Emissions Score (Step 8) using the following formula:

([Attributes Score (Step 4)]*0.33)+([GHG Emissions Score (Step 8)]*0.67)
10. Use the following formula to distribute the Combined Climate Change Scores from 1 to 100:

1+(([Combined Climate Change Scores]−[Minimum Combined Climate Change Scores in the dataset])*(100−1)/([Maximum Combined Climate Change Scores in the dataset]−[Minimum Combined Climate Change Scores in the dataset]))
11. Calculate Sector Scores.
   a. Each company in the dataset should be assigned to a unique industry or sector. For each sector in the universe, this system calculates a “sector score” which is a distribution from 1 to 100 of the Combined Climate Change Scores within each sector using the following formula:

1+(([Combined Climate Change Scores]−[Minimum Combined Climate Change Scores in the sector dataset])*(100−1)/([Maximum Combined Climate Change Scores in the sector dataset]−[Minimum Combined Climate Change Scores in the sector dataset]))
12. Calculate the Final Climate Change Category Score using the following formula that combines the Combined Climate Change Score (Step 10) with Sector Score (Step 11):

({Combined Climate Change Score (Step 10)]+[Sector Score])/2

Section 2.4: Community Category Score: Social

This section describes the calculation of an Community Category Score which may be used independently, or as a component piece of a larger aggregate ESG score. This score includes a series of attributes regarding individual companies, usually captured as true/false or yes/no data, as well as performance data elements that capture actual levels of lobbying and philanthropic giving performance.

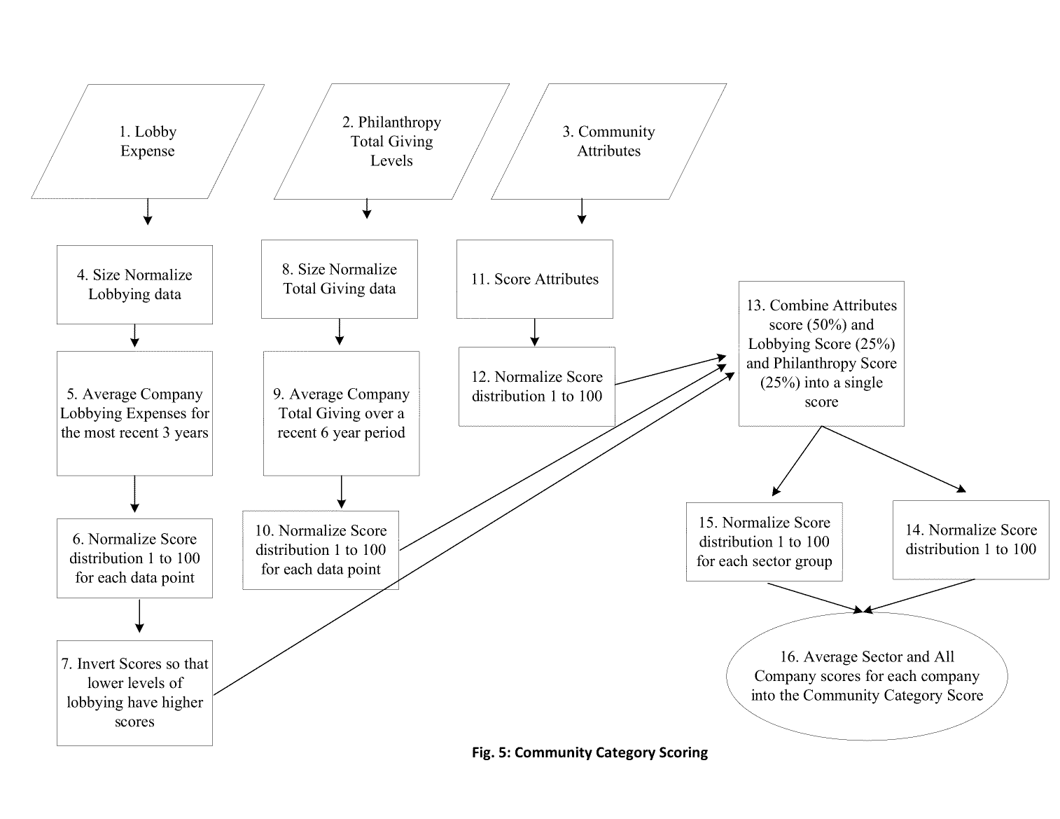

The outline below documents the specific data and calculation steps for generating the Community Category Score. For reference, FIG. 5 shows the flow of these steps. The numbers in the outline correspond with the flow chart elements in FIG. 5.
1. The Lobbying Expenses data set includes
   a. The dollar amount of Lobbying Expenses as reported to the US Congress for each of the recent three years for which data have been reported.
   b. Annual company revenue for the recent 3 year period.
2. The Philanthropy Total Giving Data includes
   a. The total disclosed annual philanthropic giving reported by companies for a recent 6 year period.
   b. Annual company revenue for the recent 6 year period.
3. The Community Attributes data includes
   a. Does the company have a publicly available policy regarding lobbying?
   b. Does the company have a publicly available policy regarding political contributions?
   c. Does the company disclose its Total Philanthropic Giving?
   d. Does the company have an operations team in charge of community involvement issues?
   e. Does the company provide support for disaster response and humanitarian relief efforts?
   f. Has the company established strategic national partnerships with community-based nonprofit organizations?
   g. Has the company established strategic community partnerships?
   h. Are the company's employees offered paid time to serve their communities?
   i. Does the company offer employees a direct opportunity to participate in company-wide service events?
   j. Does the company support employee engagement in community involvement programs?
   k. Does the company participate in community involvement programs?
4. Size normalize the Lobbying Expense data point
   a. For Lobbying Expense data, for each company, divide each year's value by the total revenue for that year.
5. For the three years of Lobbying data, calculate an average value for each company by dividing the sum of the three years of normalized data by 3.
6. Once the 3 year average of normalized Lobbying data have been calculated, distribute these scores on a scale of 1 to 100 using the following formula for each company in the data set.

1+(([3 year Average Lobbying Data]−[Minimum 3 year Average Lobbying Data in the dataset])*(100−1)/([Maximum 3 year Average Lobbying Data in the dataset]−[Minimum 3 year Average Lobbying Data in the dataset]))
7. Invert the scores in #6 above by subtracting each companies' score from 101.
8. Size normalize the Total Giving data point for each company
   a. For Total Giving data, for each company, divide each year's value by the total revenue for that year.
9. For the most recent 6 years of Total Giving data available for each company, calculate the average normalized total giving figure.
10. Once the 6 year average of normalized Total Giving data have been calculated, distribute these scores on a scale of 1 to 100 using the following formula for each company in the data set.

1+(([6 year Average Total Giving Data]−[Minimum 6 year Average Total Giving Data in the dataset])*(100−1)/([Maximum 6 year Average Total Giving Data in the dataset]−[Minimum 6 year Average Total Giving Data in the dataset]))
11. Calculate a raw score based on the Community Attributes in #3 above assigning points for each when company data answers a question in the affirmative.
   a. Does the company have a publicly available policy regarding lobbying? (5 points)
   b. Does the company have a publicly available policy regarding political contributions? (5 points)
   c. Does the company disclose its Total Philanthropic Giving? (1 point)
   d. Does the company have an operations team in charge of community involvement issues? (1 point)
   e. Does the company provide support for disaster response and humanitarian relief efforts? (1 point)
   f. Has the company established strategic national partnerships with community-based nonprofit organizations? (1 point)
   g. Has the company established strategic community partnerships? (1 point)
   h. Are the company's employees offered paid time to serve their communities? (1 point)
   i. Does the company offer employees a direct opportunity to participate in company-wide service events? (1 point)
   j. Does the company support employee engagement in community involvement programs? (1 point)
   k. Does the company participate in community involvement programs? (1 point)
12. Once the Community Attributes raw score has been calculated, distribute these scores on a scale of 1 to 100 using the following formula for each company in the data set.

1+(([Attributes Score]−[Minimum Attributes Score in the dataset])*(100−1)/([Maximum Attributes Score in the dataset]−[Minimum Attributes Score in the dataset]))
13. Calculate the “Combined Community Lobbying and Philanthropy Score” as follows:

([Attributes Score]*0.50)+([Lobbying Score]*0.25)+([Philanthropy Score]*0.25)
14. Once the “Combined Community Lobbying and Philanthropy Score” has been calculated, distribute these scores on a scale of 1 to 100 using the following formula for each company in the data set.

1+(([Combined Score]−[Minimum Combined Score in the dataset])*(100−1)/([Maximum Combined Score in the dataset]−[Minimum Combined Score in the dataset]))
15. Calculate Sector Scores
   b. Each company in the dataset should be assigned to a unique industry or sector. For each sector in the universe, this system calculates a “sector score” which is a distribution from 1 to 100 of the Combined Community Lobbying and Philanthropy Scores within each sector using the following formula:

1+(([Combined Scores]−[Minimum Combined Scores in the sector dataset])*(100−1)/([Maximum Combined Scores in the sector dataset]−[Minimum Combined Scores in the sector dataset]))
16. Calculate the Final Community Category Score using the following formula that combines the Combined Community Lobbying and Philanthropy Score (Step 14) with the Sector Score (Step 15):
17. (Combined Community Lobbying and Philanthropy Score (Step 14))+[Sector Score (Step 15)])/2

Section 2.5: Environment Category Score: Environment

This section describes the calculation of an Environment Category Score which may be used independently, or as a component piece of a larger aggregate ESG score. This score includes a series of attributes regarding individual companies, usually captured as true/false or yes/no data, as well as performance data elements that capture actual levels of environmental performance.

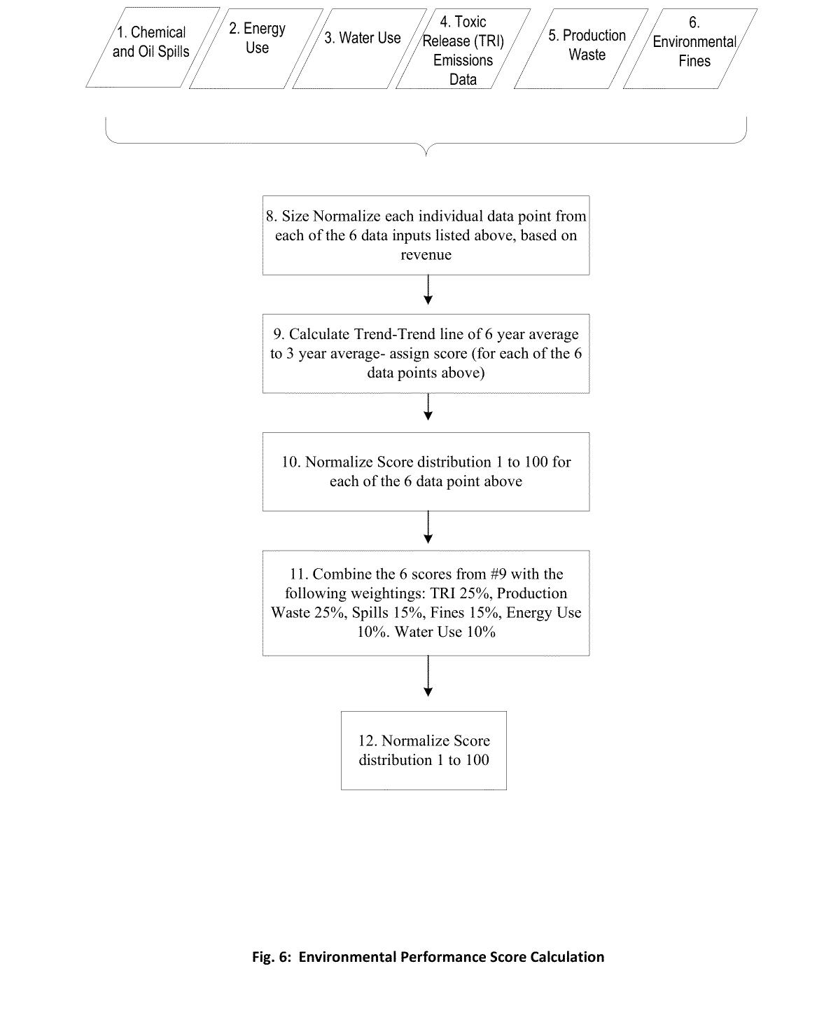

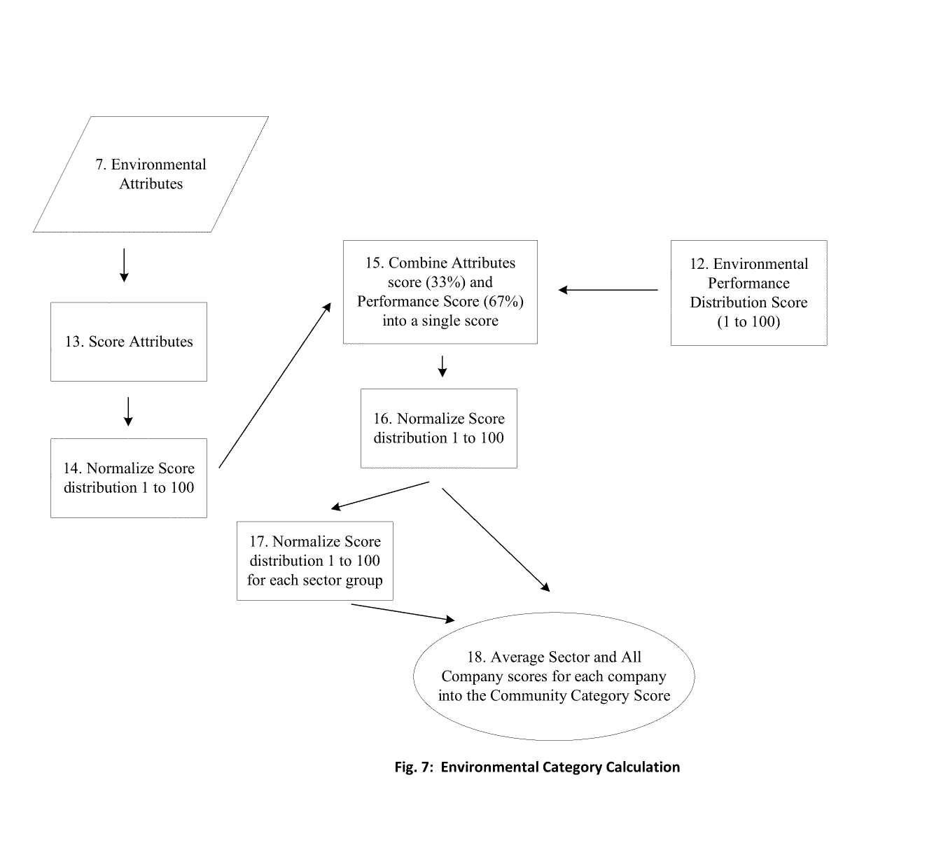

The outline below documents the specific data and calculation steps for generating the Environment Category Score. For reference, FIGS. 6 and 7 show the flow of these steps. The numbers in the outline correspond with the flow chart elements in FIGS. 6 and 7.
1. The Chemical and Oil Spills data set includes
   a. The number of annual chemical spills less than 10,000 pounds and oil spills greater than 10,000 gallons for a company as reported to the Emergency Response Notification System for a recent 6 year period.
   b. Annual company revenue for a recent 6 year period.
2. The Energy Use data set includes
   a. The annual energy use for a recent 6 year period, as reported by the company.
   b. Annual company revenue for a recent 6 year period.
3. The Water Use data set includes
   a. The annual water use for a recent 6 year period, as reported by the company.
   b. Annual company revenue for a recent 6 year period.
4. The Toxic Release Emissions (TRI) data set includes
   a. Total Pounds of emissions as reported in the US EPA TRI data set for a recent 6 year period.
   b. Annual company revenue for a recent 6 year period.
5. The Total Production Waste data set includes
   a. Total Pounds of non product output as reported in the US EPA TRI data set for a recent 6 year period.
   b. Annual company revenue for a recent 6 year period.
6. The Environmental Fines data set includes
   a. Total dollar value of environmental fines issued by US EPA for a recent 6 year period.
   b. Annual company revenue for a recent 6 year period.
7. The data set of Environmental Attributes includes:
   a. Part 1:
      i. Does the company disclose its total water use?
      ii. Does the company disclose the total costs of energy consumption?
      iii. Does the company disclose the percentage of energy used that is derived from renewable sources?
      iv. Does the company disclose its total energy use?
      v. Does the company disclose its total NMVOC emissions?
      vi. Does the company disclose its total SOx/NOx emissions?
      vii. Do the same environmental policy standards apply to franchisees?
      viii. Does the company's environmental policy address: Waste management/Recycling?
      ix. Does the company have a senior level company officer (vice-president or higher) designated as having the responsibility for oversight and/or implementation of the environmental policy?
   b. Part 2:
      i. Does the company disclose third party involvement in the development of this environmental policy?
      ii. Does the company disclose the number of personnel involved in the implementation of this environmental policy?
      iii. Does the company have a department or staff dedicated to the implementation of this environmental policy?
      iv. Does the policy specifically reference areas of challenge for the company and its industry?
      v. Is the Board of Directors specifically mentioned as having responsibility for the environmental policy?
      vi. Does the environmental policy include a commitment to quantifiable targets or goals?
      vii. Does the environmental policy include a commitment to third-party auditing?
      viii. Does the environmental policy include a commitment to public reporting?
      ix. Does the environmental policy include discrete, actionable elements from which programs can be derived and/or progress measured?
   c. Part 3:
      i. Does the environmental policy include a commitment to stakeholder involvement in the development of the policy, the implementation of the policy, and/or the evaluation of effective outcomes of the policy's implementation?
      ii. Is the environmental policy a global policy applying the same comprehensive standards to all company operations regardless of geographic location?
      iii. Do the same standards found in the company's environmental policy apply to partners?
      iv. Do the same environmental policy standards apply to suppliers/vendors?
      v. Is there a component of the environmental policy addressing partners? Included in this are business partnerships and joint venture participants.
      vi. Is there a component of the environmental policy addressing suppliers/vendors? Included in this are the company's direct supply chain, contracted sub-assemblers or custom fabricators, and providers of critical services (excluding fungible services).
      vii. Does the environmental policy specifically apply to all company operations?
      viii. Does the company's environmental policy address: Water use/conservation?
      ix. Does the company's environmental policy address: Energy use/conservation?
   d. Part 4:
      i. Does the company's environmental policy address: Other emissions?
      ii. Does the company's environmental policy address: Green house gases?
      iii. Does the company have an enterprise level environmental policy?
      iv. Does the company disclose its hazardous waste generation for any of its operations located outside the U.S. (at any level other than enterprise, including facility, business unit, region, etc.)?
      v. Does the company disclose details regarding its hazardous waste disposal program?
      vi. Does the company disclose its hazardous waste generation at any level other than enterprise (including facility, business unit, region, etc.)?
      vii. Does the company disclose a normalized total hazardous waste generation value?
      viii. Does the company disclose its total hazardous waste generation?
      ix. Does the company disclose what the primary hazardous waste materials it generates are?
   e. Part 5:
      i. Does the company's GRI Index indicate that the company discloses the monetary value of significant fines and total number of non-monetary sanctions/convictions for non-compliance with environmental laws and regulations?
      ii. Does the company's GRI Index indicate that the company discloses weight of transported, imported, exported, or treated waste deemed hazardous under the terms of the Basel Convention Annex I, II, III, and VIII, and percentage of transported waste shipped internationally?
      iii. Does the company disclose its savings or profits as a result of water conservation programs for any of its operations located outside the U.S. (at any level other than enterprise, including facility, business unit, region, etc.)?
      iv. Does the company disclose its water conservation results for any of its operations located outside the U.S. (at any level other than enterprise, including facility, business unit, region, etc.)?
      v. Does the company disclose its savings or profits as a result of energy conservation programs for any of its operations located outside the U.S. (at any level other than enterprise, including facility, business unit, region, etc.)?
      vi. Does the company disclose its energy conservation results for any of its operations located outside the U.S. (at any level other than enterprise, including facility, business unit, region, etc.)?
      vii. Are incentives given to employees for meeting company water conservation goals?
      viii. Does the company disclose the associated savings or profits achieved as a result of water conservation programs for any level other than enterprise (including facility, business unit, region, etc.)?
      ix. Does the company disclose the amount of investment in water conservation programs at any level other than enterprise (including facility, business unit, region, etc.)?
   f. Part 6:
      i. Does the company disclose the associated total savings or profits achieved as a result of water conservation programs?
      ii. Does the company disclose the amount of total investment in water conservation programs?
      iii. Does the company disclose its water conservation resulting from such programs at any level other than enterprise (including facility, business unit, region, etc.)?
      iv. Does the company disclose the total amount of water conserved through its water conservation programs?
      v. Are incentives given to employees for meeting company energy conservation goals?
      vi. Does the company provide/promote mass transit or similar transportation system(s) for employees that promote energy conservation?
      vii. Does the company disclose the associated savings or profits achieved as a result of energy conservation programs for any level other than enterprise (including facility, business unit, region, etc.)?
      viii. Does the company disclose the amount of investment in energy conservation programs at any level other than enterprise (including facility, business unit, region, etc.)?
      ix. Does the company disclose the associated total savings or profits achieved as a result of energy conservation programs?
   g. Part 7:
      i. Does the company disclose the amount of total investment in energy conservation programs?
      ii. Does the company disclose its energy conservation resulting from such programs at any level other than enterprise (including facility, business unit, region, etc.)?
      iii. Does the company disclose the total amount of energy conserved through its energy conservation programs?
      iv. Does the company disclose the total amount of recycled materials? (1 point)
      v. Does the company disclose the use of any recycled materials in its packaging?
      vi. Does the company use recycled paper in its products?
      vii. Does the company have a solid waste management program?
      viii. Does the company have a chemical waste management program?
   h. Part 8:
      i. Does the company have a consumer product waste management program?
      ii. Does the company have a packaging waste management program?
      iii. Does the company have a production waste management program?
      iv. Does the company have a business waste management program?
      v. Does the company have any other waste management programs?
   i. NOTE THERE IS NO Part 9 IN THE QUERY
   j. Part 10
      i. Does the company have a water recycling program?
      ii. Does the company disclose the use of any recycled materials in its products?
      iii. Does the company have a consumer product recycling program?
      iv. Does the company have a packaging waste recycling program?
      v. Does the company have a production waste recycling program?
      vi. Does the company have a business waste recycling program?
      vii. Does the company have any other recycling programs?
   k. Part 11:
      i. Is the company as a whole ISO 14001 attested?
      ii. Is the company as a whole ISO 14001 certified?
   l. Part 12:
      i. Does the company disclose the presence of an Environmental Management System?
      ii. Does the company include information concerning employee training in its EHS/CSR report?
      iii. Does the company disclose health/safety fines and/or violations?
      iv. Does the company disclose environmental fines and/or violations?
8. Size normalize each environmental performance data point (chemical and oil spills, energy use, water use, toxic release emissions, production waste, and environmental fines)
   c. For each data element, for each company, divide each year's value by the total revenue for that year.
9. Calculate Trend lines for chemical and oil spills, energy use, water use, toxic release emissions, production waste, and environmental fines
   a. For each data element
      i. Calculate the average revenue normalized value for the recent 6 years available in the dataset.
      ii. Calculate the average revenue normalized value for the recent 3 years available in the dataset.
      iii. Calculate “6 year percentage” for each company as follows:
         1. [6 year average]/[maximum 6 year average from the dataset]
         2. Calculate the Trend Line using the following formula: ([3 year average]−[6 year average])/[6 year average]
         3. Assign Trend Line Scores as follows:
         4. If the Trend Line is negative (less than 0), “trends line temp score” 3
         5. If the Trend Line is greater than 1, “trends line temp score” 1
         6. If the Trend Line is less than 1 and greater than 0, then assign “trends line temp score” equal to the trend line calculation
      iv. Calculate Trend Line Score using the following formula

1−(2*([6 year percentage]−[trend line temp score])
10. Once the Trend Line Scores have been calculated for each of the 6 environmental performance elements across the entire universe of companies, distribute these scores on a scale of 1 to 100 using the following formula for each company in the data set.
   d. Use the following formula to distribute the Data Element Trend Line Score:

1+(([Data Element Trend Line Score]−[Minimum Data Element Trend Line Score in the dataset])*(100−1)/([Maximum Data Element Trend Line Score in the dataset]−[Minimum Data Element Trend Line Score in the dataset]))
11. Calculate the preliminary Environmental Performance Score using the distributed scores for each data element calculated in #10 above, using the following formula:

([Toxic emissions]*0.25+([Production waste]*0.25+([Chemical and oil spills]*0.15+([Environmental fines]*0.15+([Energy use]*0.1+([Water use]*0.1
12. Once the preliminary Environmental Performance Score has been calculated, distribute the score on a scale of 1 to 100 using the following formula for each company in the data set.
   a. Use the following formula to distribute the Data Element Trend Line Score:

1+(([Data Element Trend Line Score]−[Minimum Data Element Trend Line Score in the dataset])*(100−1)/([Maximum Data Element Trend Line Score in the dataset]−[Minimum Data Element Trend Line Score in the dataset]))
13. Calculate a raw score based on the attributes data list in #7 above assigning points as follows:
   a. Part 1:
      i. Does the company disclose its total water use? (3 points)
      ii. Does the company disclose the total costs of energy consumption? (1 point)
      iii. Does the company disclose the percentage of energy used that is derived from renewable sources? (1 point)
      iv. Does the company disclose its total energy use? (3 points)
      v. Does the company disclose its total NMVOC emissions? (1 point)
      vi. Does the company disclose its total SOx/NOx emissions? (1 point)
      vii. Do the same environmental policy standards apply to franchisees? (1 point)
      viii. Does the company's environmental policy address: Waste management/Recycling? (1 point)
      ix. Does the company have a senior level company officer (vice-president or higher) designated as having the responsibility for oversight and/or implementation of the environmental policy? (1 point)
   b. Part 2:
      i. Does the company disclose third party involvement in the development of this environmental policy? (1 point)
      ii. Does the company disclose the number of personnel involved in the implementation of this environmental policy? (1 point)
      iii. Does the company have a department or staff dedicated to the implementation of this environmental policy? (1 point)
      iv. Does the policy specifically reference areas of challenge for the company and its industry? (1 point)
      v. Is the Board of Directors specifically mentioned as having responsibility for the environmental policy? (5 points)
      vi. Does the environmental policy include a commitment to quantifiable targets or goals? (3 points)
      vii. Does the environmental policy include a commitment to third-party auditing? (1 point)
      viii. Does the environmental policy include a commitment to public reporting? (1 point)
      ix. Does the environmental policy include discrete, actionable elements from which programs can be derived and/or progress measured? (1 point)
   c. Part 3:
      i. Does the environmental policy include a commitment to stakeholder involvement in the development of the policy, the implementation of the policy, and/or the evaluation of effective outcomes of the policy's implementation? (1 point)
      ii. Is the environmental policy a global policy applying the same comprehensive standards to all company operations regardless of geographic location? (2 points)
      iii. Do the same standards found in the company's environmental policy apply to partners? (1 point)
      iv. Do the same environmental policy standards apply to suppliers/vendors? (1 point)
      v. Is there a component of the environmental policy addressing partners? Included in this are business partnerships and joint venture participants. (1 point)
      vi. Is there a component of the environmental policy addressing suppliers/vendors? Included in this are the company's direct supply chain, contracted sub-assemblers or custom fabricators, and providers of critical services (excluding fungible services). (1 point)
      vii. Does the environmental policy specifically apply to all company operations? (3 points)
      viii. Does the company's environmental policy address: Water use/conservation? (1 point)
      ix. Does the company's environmental policy address: Energy use/conservation? (1 point)
   d. Part 4:
      i. Does the company's environmental policy address: Other emissions? (1 point)
      ii. Does the company's environmental policy address: Green house gases? (1 point)
      iii. Does the company have an enterprise level environmental policy? (10 points)
      iv. Does the company disclose its hazardous waste generation for any of its operations located outside the U.S. (at any level other than enterprise, including facility, business unit, region, etc.)? (1 point)
      v. Does the company disclose details regarding its hazardous waste disposal program? (1 point)
      vi. Does the company disclose its hazardous waste generation at any level other than enterprise (including facility, business unit, region, etc.)? (1 point)
      vii. Does the company disclose a normalized total hazardous waste generation value? (1 point)
      viii. Does the company disclose its total hazardous waste generation? (1 point)
      ix. Does the company disclose what the primary hazardous waste materials it generates are? (1 point)
   e. Part 5:
      i. Does the company's GRI Index indicate that the company discloses the monetary value of significant fines and total number of non?monetary sanctions/convictions for non-compliance with environmental laws and regulations? (1 point)
      ii. Does the company's GRI Index indicate that the company discloses weight of transported, imported, exported, or treated waste deemed hazardous under the terms of the Basel Convention Annex I, II, III, and VIII, and percentage of transported waste shipped internationally? (1 point)
      iii. Does the company disclose its savings or profits as a result of water conservation programs for any of its operations located outside the U.S. (at any level other than enterprise, including facility, business unit, region, etc.)? (1 point)
      iv. Does the company disclose its water conservation results for any of its operations located outside the U.S. (at any level other than enterprise, including facility, business unit, region, etc.)? (1 point)
      v. Does the company disclose its savings or profits as a result of energy conservation programs for any of its operations located outside the U.S. (at any level other than enterprise, including facility, business unit, region, etc.)? (1 point)
      vi. Does the company disclose its energy conservation results for any of its operations located outside the U.S. (at any level other than enterprise, including facility, business unit, region, etc.)? (1 point)
      vii. Are incentives given to employees for meeting company water conservation goals? (2 points)
      viii. Does the company disclose the associated savings or profits achieved as a result of water conservation programs for any level other than enterprise (including facility, business unit, region, etc.)? (1 point)
      ix. Does the company disclose the amount of investment in water conservation programs at any level other than enterprise (including facility, business unit, region, etc.)? (1 point)
   f. Part 6:
      i. Does the company disclose the associated total savings or profits achieved as a result of water conservation programs? (1 point)
      ii. Does the company disclose the amount of total investment in water conservation programs? (1 point)
      iii. Does the company disclose its water conservation resulting from such programs at any level other than enterprise (including facility, business unit, region, etc.)? (1 point)
      iv. Does the company disclose the total amount of water conserved through its water conservation programs? (1 point)
      v. Are incentives given to employees for meeting company energy conservation goals? (2 points)
      vi. Does the company provide/promote mass transit or similar transportation system(s) for employees that promote energy conservation? (1 point)
      vii. Does the company disclose the associated savings or profits achieved as a result of energy conservation programs for any level other than enterprise (including facility, business unit, region, etc.)? (1 point)
      viii. Does the company disclose the amount of investment in energy conservation programs at any level other than enterprise (including facility, business unit, region, etc.)? (1 point)
      ix. Does the company disclose the associated total savings or profits achieved as a result of energy conservation programs? (1 point)
   g. Part 7:
      i. Does the company disclose the amount of total investment in energy conservation programs? (1 point)
      ii. Does the company disclose its energy conservation resulting from such programs at any level other than enterprise (including facility, business unit, region, etc.)? (1 point)
      iii. Does the company disclose the total amount of energy conserved through its energy conservation programs? (1 point)
      iv. Does the company disclose the total amount of recycled materials? (1 point)
      v. Does the company disclose the use of any recycled materials in its packaging? (1 point)
      vi. Does the company use recycled paper in its products? (1 point)
      vii. Does the company have a solid waste management program? (1 point)
      viii. Does the company have a chemical waste management program? (1 point)
   h. Part 8: If at least one of the following is true, then assign 1 point.
      i. Does the company have a consumer product waste management program?
      ii. Does the company have a packaging waste management program?
      iii. Does the company have a production waste management program?
      iv. Does the company have a business waste management program?
      v. Does the company have any other waste management programs?
   i. NOTE THERE IS NO Part 9 IN THE QUERY
   j. Part 10: If at least one of the following is true, then assign 1 point.
      i. Does the company have a water recycling program?
      ii. Does the company disclose the use of any recycled materials in its products?
      iii. Does the company have a consumer product recycling program?
      iv. Does the company have a packaging waste recycling program?
      v. Does the company have a production waste recycling program?
      vi. Does the company have a business waste recycling program?
      vii. Does the company have any other recycling programs?
   k. Part 11:
      i. Is the company as a whole ISO 14001 attested? (1 point)
      ii. Is the company as a whole ISO 14001 certified? (1 point)
   l. Part 12:
      i. Does the company disclose the presence of an Environmental Management System? (1 point)
      ii. Does the company include information concerning employee training in its EHS/CSR report? (1 point)
      iii. Does the company disclose health/safety fines and/or violations? (1 point)
      iv. Does the company disclose environmental fines and/or violations? (1 point)
14. Once the preliminary Environmental Performance Score has been calculated, distribute the score on a scale of 1 to 100 using the following formula for each company in the data set.
   a. Use the following formula to distribute the Data Element Trend Line Score:

1+(([Attributes Score]−[Minimum Attributes Score in the dataset])*(100−1)/([Maximum Attributes Score in the dataset]−[Minimum Attributes Score in the dataset]))
15. Calculate “Combined Environment Scores” for each company, combine the Attributes Score (Step 14) with the Performance Score (Step 12) using the following formula:

([Attributes Score (Step 14)]*0.33)+([Environmental Performance Score (Step 12)]*0.67)
16. Use the following formula to distribute the Combined Environment Scores from 1 to 100:

1+(([Combined Environment Scores]−[Minimum Combined Environment Scores in the dataset])*(100−1)/([Maximum Combined Environment Scores in the dataset]−[Minimum Combined Environment Scores in the dataset]))
17. Calculate Sector Scores.
   e. Each company in the dataset should be assigned to a unique industry or sector. For each sector in the universe, this system calculates a “sector score” which is a distribution from 1 to 100 of the Combined Environment Scores within each sector using the following formula:

1+(([Combined Environment Scores]−[Minimum Combined Environment Scores in the sector dataset])*(100−1)/([Maximum Combined Environment Scores in the sector dataset]−[Minimum Combined Environment Scores in the sector dataset]))
18. Calculate the Final Environment Category Score using the following formula that combines the Combined Environment Score (Step 16) with Sector Score (Step 17):

([Combined Environment Score (Step 16)]+[Sector Score (Step 17)])

Section 2.6: Governance Category Score: Governance

This section describes the calculation of a Governance Category Score which may be used independently, or as a component piece of a larger aggregate ESG score. This score includes a series of attributes regarding individual companies, usually captured as true/false or yes/no data, as well as performance data elements that capture actual levels of governance performance.

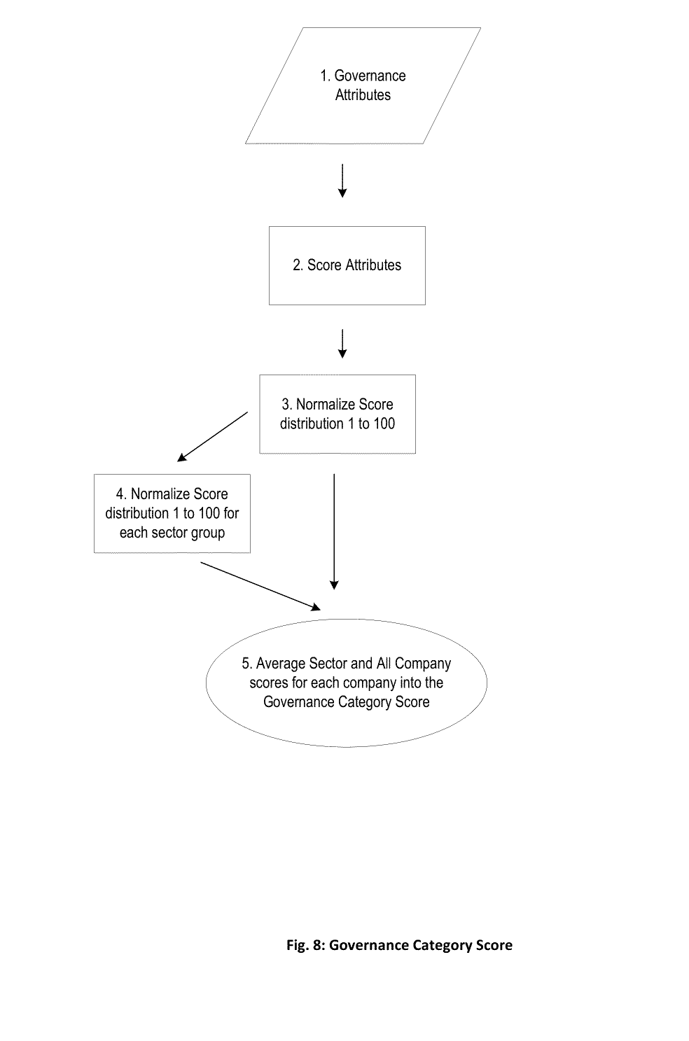

The outline below documents the specific data and calculation steps for generating the Governance Category Score. For reference, FIG. 8 shows the flow of these steps. The numbers in the outline correspond with the flow chart elements in FIG. 8.
1. The data set of Governance Attributes includes:
   a. Part 1:
      i. Does the company have a committee or executive team responsible for sustainability related issues?
      ii. Does the company have a majority of independent directors?
      iii. Did the company restate financials three years ago?
      iv. Did the company restate financials two years ago?
      v. Did the company restate financials in the most recent year?
      vi. Does the company formal minimum qualifications for directors or director candidates?
      vii. Is there a CEO succession plan?
      viii. Does the company's governance documents and/or charter include a provision allowing shareholders to call a special meeting?
      ix. Does the company have a disclosed “poison pill” takeover defense?
      x. Does the company disclose incorrect balance or accounting practices within the past three years?
   b. Part 2:
      i. What is the disclosed percentage of fees paid for audits?
      ii. What percentage of the members of the nominating committee are independent directors
      iii. What percentage of the members of the governance committee are independent directors?
      iv. What percentage of the members of the compensation committee are independent directors?
      v. +IIf(IsNull(Governance!CGOV_045),0,(Governance!CGOV_045/100))
      vi. +IIf(Governance!CGOV_052=“true”,1,0) Does the Board of Directors include a described financial expert?
   c. Part 3:
      i. What percentage of the board of directors are independent?
   d. Part 4: What is the total number of directors on the Board of Directors? And what is the total number of independent (non management) directors on the Board of Directors?
   e. Part 5:
      i. Are the positions of CEO and Chairman of the Board held by different people?
      ii. What is the organization of the Board of Directors? (Are all the directors elected annually, or is the board divided into classes?)
   f. Part 6:
      i. Does the company publicly disclose its Code of Conduct?
      ii. Does the company disclose third party involvement in the development of this ethics program?
      iii. Does the corporate ethics program include a commitment to third-party auditing?
      iv. Does the corporate ethics program include a commitment to auditing?
      v. Does the corporate ethics program include public reporting of results?
      vi. Does the company disclose the number of personnel involved in the implementation of this ethics program?
      vii. Does the company have a department or staff dedicated to the implementation of this ethics program?
      viii. Does the company have a senior level company officer responsible for the implementation of this ethics program?
      ix. Is the Board of Directors specifically mentioned as having responsibility for the ethics program?
      x. Does the company pay for performance based on its ethics program?
      xi. Does the company have an annual certification based on ethics training?
      xii. Does the company require annual ethics training for employees and officers?
      xiii. Does the corporate ethics program include any quantifiable targets or goals?
      xiv. Does the company disclose a corporate ethics program?
      xv. Does the company have a whistleblower policy?
      xvi. Does the company have a grievance policy?
2. Calculate a raw score based on the attributes list in #2 above assigning points as follows:
   a. Part 1:
      i. Does the company have a committee or executive team responsible for sustainability related issues? (1 point)
      ii. Does the company have a majority of independent directors? (1 point)
      iii. Did the company restate financials three years ago? (−1 point)
      iv. Did the company restate financials two years ago? (−1 point)
      v. Did the company restate financials in the most recent year? (−1 point)
      vi. Does the company formal minimum qualifications for directors or director candidates? (1 point)
      vii. Is there a CEO succession plan? (1 point)
      viii. Does the company's governance documents and/or charter include a provision allowing shareholders to call a special meeting? (1 point)
      ix. Does the company have a disclosed “poison pill” takeover defense? (−3 point)
      x. Does the company disclose incorrect balance or accounting practices within the past three years? (−1 point)
   b. Part 2:
      i. What is the disclosed percentage of fees paid for audits? (up to 1 point)
      ii. What percentage of the members of the nominating committee are independent directors? (up to 1 point)
      iii. What percentage of the members of the governance committee are independent directors? (up to 1 point)
      iv. What percentage of the members of the compensation committee are independent directors? (up to 1 point)
      v. +IIf(IsNull(Governance!CGOV_045),0,(Governance!CGOV_045/100)) (1 point)
      vi. +IIf(Governance!CGOV_052=“true”,1,0) Does the Board of Directors include a described financial expert? (1 point)
   c. Part 3:
      i. What percentage of the board of directors are independent?
         1. <50% (0 points)
         2. <75% (5 points)
         3. <90%(7 points)
         4. >=90% (8 points)
   d. Part 4: What is the total number of directors on the Board of Directors? And What is the total number of independent directors on the Board of Directors?
      i. If all but one director are independent, then increase Part 3 Score to 10 points.
   e. Part 5:
      i. Are the positions of CEO and Chairman of the Board held by different people? (1 point)
      ii. What is the organization of the Board of Directors? (1 point if declassified)
   f. Part 6:
      i. Does the company publicly disclose its Code of Conduct? (1 point)
      ii. Does the company disclose third party involvement in the development of this ethics program? (1 point)
      iii. Does the corporate ethics program include a commitment to third-party auditing? (1 point)
      iv. Does the corporate ethics program include a commitment to auditing? (1 point)
      v. Does the corporate ethics program include public reporting of results? (1 point)
      vi. Does the company disclose the number of personnel involved in the implementation of this ethics program? (1 point)
      vii. Does the company have a department or staff dedicated to the implementation of this ethics program? (1 point)
      viii. Does the company have a senior level company officer responsible for the implementation of this ethics program? (1 point)
      ix. Is the Board of Directors specifically mentioned as having responsibility for the ethics program? (2 point)
      x. Does the company pay for performance based on its ethics program? (1 point)
      xi. Does the company have an annual certification based on ethics training? (1 point)
      xii. Does the company require annual ethics training for employees and officers? (1 point)
      xiii. Does the corporate ethics program include any quantifiable targets or goals? (1 point)
      xiv. Does the company disclose a corporate ethics program? (1 point)
      xv. Does the company have a whistleblower policy? (1 point)
      xvi. Does the company have a grievance policy? (1 point)
   g. Sum the totals of Part 1 through Part 6
3. Once the preliminary Governance Attributes Score has been calculated, distribute the score on a scale of 1 to 100 using the following formula for each company in the data set. Use the following formula to distribute the Attribute Score:

1+(([Attribute Score]−[Minimum Attribute Score in the dataset])*(100−1)/([Maximum Attribute Score in the dataset]−[Minimum Attribute Score in the dataset]))
4. Calculate Sector Scores. Each company in the dataset should be assigned to a unique industry or sector (i.e. any sector or industry classification scheme). For each sector in the universe, this system calculates a “sector score” which is a distribution from 1 to 100 of the Governance Attributes Scores within each sector using the following formula:

1+(([Governance Attributes Scores]−[Minimum Governance Attributes Scores in the sector dataset])*(100−1)/([Maximum Governance Attributes Scores in the sector dataset]−[Minimum Governance Attributes Scores in the sector dataset]))
5. Calculate the Final Governance Category Score using the following formula that combines the Governance Attributes Score (Step 3) with Sector Score (Step 4):

([Governance Attributes Score (Step 3)]+[Sector Score (Step 4)])/2

Section 2.7: Human Rights and Labor Category Score: Social

This section describes the calculation of a Human Rights and Labor Category Score which may be used independently, or as a component piece of a larger aggregate ESG score. This score includes a series of attributes regarding individual companies, usually captured as true/false or yes/no data, as well as performance data elements that capture actual levels of human rights and labor performance.

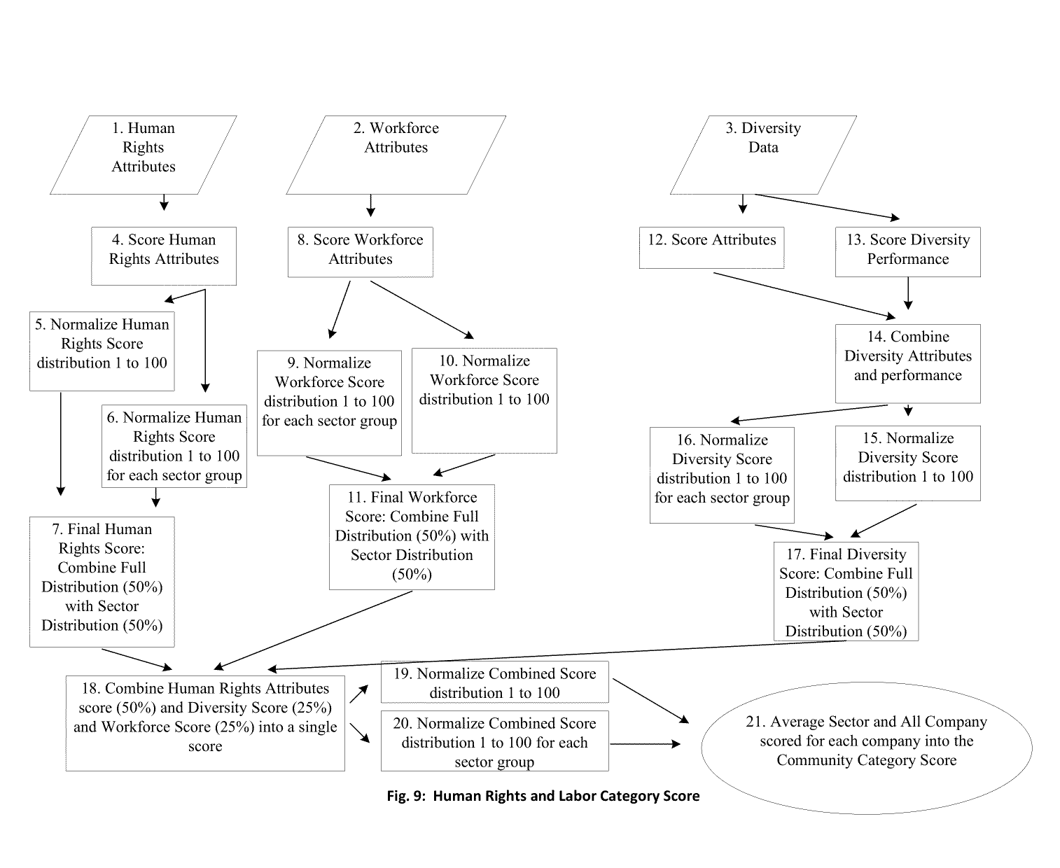

The outline below documents the specific data and calculation steps for generating the Human Rights and Labor Category Score. For reference, FIG. 9 shows the flow of these steps. The numbers in the outline correspond with the flow chart elements in FIG. 9.
1. The data set of human rights attributes includes:
   a. Part 1:
      i. Has the company had fines levied against it by any governmental organization in the past 5 years related to human rights issues?
      ii. Has the company been involved in any litigation, pending or settled, related to human rights issues in the past 5 years?
      iii. Does the company publicly disclose through non-mandated channels any human rights controversies or related legal actions it has been linked to in the past 5 years?
      iv. Does the company have a stated minimum age of employment?
      v. Does the company make a commitment to the provision of competitive compensation and benefits to its workforce?
      vi. Does the company have a clearly stated policy regarding the protection of workers' rights?
      vii. Is there a component of the company's human rights policy addressing suppliers/vendors? Included in this are the company's direct supply chain, contracted sub-assemblers or custom fabricators, and providers of critical important services (excluding fungible services
      viii. Does the company have an enterprise level human rights policy?
      ix. Do the same human rights policy standards apply to franchisees? This excludes joint ventures and direct business partnerships.
      x. Does the company's human rights policy include a training element?
   b. Part 2:
      i. Does the company have a senior level company officer (vice-president or higher) designated as having the responsibility for oversight and/or implementation of the company's human rights policy?
      ii. Does the company's human rights policy specifically reference areas of challenge for the company and its industry?
      iii. Does the company disclose third party involvement in the development of the company's human rights policy?
      iv. Does the company disclose the number of personnel involved in the implementation of the company's human rights policy?
      v. Does the company have a department or staff dedicated to the implementation of the company's human rights policy?
      vi. Is the Board of Directors specifically mentioned as having responsibility for the company's human rights policy?
      vii. Does the company's human rights policy include a commitment to quantifiable targets or goals?
      viii. Does the company's human rights policy include a commitment to third-party auditing?
      ix. Does the company's human rights policy include a commitment to public reporting?
      x. Does the company's human rights policy include discrete, actionable elements from which programs can be derived and/or progress measured?
   c. Part 3:
      i. Does the company's human rights policy include a commitment to stakeholder involvement in the development of the policy, the implementation of the policy, and/or the evaluation of effective outcomes of the policy's implementation?
      ii. Is the company's human rights policy a global policy applying the same comprehensive standards to all company operations regardless of geographic location?
      iii. Do the same human rights policy standards apply to partners? (1 point)
      iv. Do the same human rights policy standards apply to suppliers/vendors?
      v. Is there a component of the company's human rights policy addressing partners? Included in this are business partnerships and joint venture participants.
      vi. Is there a component of the company's human rights policy addressing suppliers/vendors?
      vii. Does the company's human rights policy specifically apply to all company operations?
      viii. Does the company's policy guarantee employees the right to organize?
      ix. Does the company's human rights policy have clear reference to conformance with the UN Universal Declaration of Human Rights?
      x. Does the company's human rights policy have clear reference to conformance with ILO standards?
   d. Part 4:
      i. Does the company's human rights policy address the protection of indigenous peoples' rights?
      ii. Does the company's human rights policy address the issue of child labor?
      iii. Does the company's human rights policy address the issues of forced labor, prison labor, and/or indentured labor?
      iv. Does the company make a commitment to the provision of competitive compensation and benefits to its workforce?
      v. Does the company's human rights policy address the protection of workers' rights?
      vi. Does the company's human rights policy address the protection of women's rights?
      vii. Does the company have a clearly stated policy regarding the employment of women?
      viii. Does the company make a commitment to the provision of fair and equal wages to employees regardless of gender?
      ix. Does the company's human rights policy address the protection of minority groups' rights?
      x. Does the company have a clearly stated policy regarding the employment of minorities?
   e. Freedom House Evaluation: Freedom House is an organization that evaluates countries based on civil and political liberties. It scores countries on a scale of 1 to 7 in each of these categories. By summing the political and civil liberty scores for each country, this evaluation starts with a country score ranging from 2 to 14. The higher the number, the less free and more oppressive a country is. Based on the operations that companies have in countries, this data identifies the least free/most oppressive country in which a company has operations.
2. The data set of workforce attributes includes:
   a. Part 1:
      i. What is the degree of disclosure by the company regarding the benefits it offers its employees Detailed, Limited, or None?
      ii. Does the company make a commitment to the provision of fair and equal wages to employees regardless of gender?
      iii. Does the company itself disclose that it has been subject to organized labor actions, including strikes, at any of its U.S. or non U.S. locations involving at least 100 employees and lasting at least 21 calendar days within the last 12 months?
      iv. Does the company disclose the composition of its workforce by employment status?
      v. Does the company disclose information regarding employee-turnover rate
      vi. Does the company disclose the number of employee deaths?
   b. Part 2:
      i. Does the company disclose how many hours of training each existing employee receives per year?
      ii. Does the company disclose how many hours of safety training employees receive within a year?
      iii. Does the company disclose the presence of any other training programs it provides to its employees?
      iv. Does the company disclose the presence of any safety training programs for employees?
      v. Has the company been fined or disciplined by the Equal Employment Opportunity Commission (EEOC) in the past 3 years?
      vi. Has the company been subject to organized labor actions, including strikes, at any of its U.S. locations involving at least 100 employees and lasting at least 21 calendar days within the last 12 months?
      vii. Does the company include information concerning employee training in its EHS/CSR report?
      viii. Does the company have an enterprise level workforce policy?
   c. Part 3:
      i. Do the same workforce policy standards apply to franchisees?
      ii. Does the company's workforce policy specifically reference areas of challenge for the company and its industry?
      iii. Does the company disclose third party involvement in the development of these policies?
      iv. Does the company disclose the number of personnel involved in the implementation of these policies?
      v. Does the company have a department or staff dedicated to the implementation of any of these policies?
      vi. Is the Board of Directors specifically mentioned as having responsibility for any of the policies?
      vii. Do any of the policies include a commitment to third-party auditing?
      viii. Do any of the policies include a commitment to public reporting?
      ix. Is there a commitment to stakeholder involvement in the policies?
      x. Is the company's workforce policy a global workforce policy (other than saying the workforce policy is to comply with local laws)?
   d. Workforce Step 1: [Part 1]+[part 2]+[PART 3]
3. The data set of diversity attributes and performance includes
   a. Does the company have a clearly stated policy regarding the protection of minority groups' rights?
   b. Does the company disclose the percentage of new hires that is considered to be a member of a minority group?
   c. Does the company have a clearly stated policy regarding the use of suppliers that are female- or minority-owned?
   d. Does the company have a clearly stated policy regarding the protection of women's rights?
   e. Does the company disclose the percentage of new hires that is female?
   f. Does the company disclose the composition of its workforce by location?
   g. Does the company provide any workforce demographic disclosure by age?
   h. Does the company provide any workforce demographic disclosure by ethnicity?
   i. Does the company provide any workforce demographic disclosure by race?
   j. Does the company provide any workforce demographic disclosure by gender?
   k. Does the company provide any demographic disclosure (limited to gender, race, ethnicity, age, and similar categories) regarding the composition of its workforce?
   l. What is the percentage of the company's management force that considered to be a member of a minority group?
   m. What is the percentage of the company's workforce that is considered to be a member of a minority group?
   n. What is the percentage of the company's management force that is female?
   o. What is the percentage of the company's workforce that is female?
4. Calculate the score for the human rights attributes by assigning the following points to each of the attributes listed in #1 above:
   a. Part 1:
      i. Has the company had fines levied against it by any governmental organization in the past 5 years related to human rights issues? (−2 points)
      ii. Has the company been involved in any litigation, pending or settled, related to human rights issues in the past 5 years? (−2 points)
      iii. Does the company publicly disclose through non-mandated channels any human rights controversies or related legal actions it has been linked to in the past 5 years? (1 point)
      iv. Does the company have a stated minimum age of employment? (1 point)
      v. Does the company make a commitment to the provision of competitive compensation and benefits to its workforce? (1 point)
      vi. Does the company have a clearly stated policy regarding the protection of workers' rights? (1 point)
      vii. Is there a component of the company's human rights policy addressing suppliers/vendors? Included in this are the company's direct supply chain, contracted sub-assemblers or custom fabricators, and providers of services (excluding fungible services) (1 point)
      viii. Does the company have an enterprise level human rights policy? (10 points)
      ix. Do the same human rights policy standards apply to franchisees? This excludes joint ventures and direct business partnerships. (1 point)
      x. Does the company's human rights policy include a training element? (1 point)
   b. Part 2:
      i. Does the company have a senior level company officer (vice-president or higher) designated as having the responsibility for oversight and/or implementation of the company's human rights policy? (1 point)
      ii. Does the company's human rights policy specifically reference areas of challenge for the company and its industry? (1 point)
      iii. Does the company disclose third party involvement in the development of the company's human rights policy? (1 point)
      iv. Does the company disclose the number of personnel involved in the implementation of the company's human rights policy? (1 point)
      v. Does the company have a department or staff dedicated to the implementation of the company's human rights policy? (1 point)
      vi. Is the Board of Directors specifically mentioned as having responsibility for the company's human rights policy? (1 point)
      vii. Does the company's human rights policy include a commitment to quantifiable targets or goals? (3 points)
      viii. Does the company's human rights policy include a commitment to third-party auditing? (1 point)
      ix. Does the company's human rights policy include a commitment to public reporting? (5 points)
      x. Does the company's human rights policy include discrete, actionable elements from which programs can be derived and/or progress measured? (1 point)
   c. Part 3:
      i. Does the company's human rights policy include a commitment to stakeholder involvement in the development of the policy, the implementation of the policy, and/or the evaluation of effective outcomes of the policy's implementation? (1 point)
      ii. Is the company's human rights policy a global policy applying the same comprehensive standards to all company operations regardless of geographic location? (2 points)
      iii. Do the same human rights policy standards apply to partners? (1 point)
      iv. Do the same human rights policy standards apply to suppliers/vendors? (1 point)
      v. Is there a component of the company's human rights policy addressing partners? Included in this are business partnerships and joint venture participants. (1 point)
      vi. Is there a component of the company's human rights policy addressing suppliers/vendors? (1 point)
      vii. Does the company's human rights policy specifically apply to all company operations? (3 points)
      viii. Does the company's policy guarantee employees the right to organize? (3 points)
      ix. Does the company's human rights policy have clear reference to conformance with the UN Universal Declaration of Human Rights? (1 point)
      x. Does the company's human rights policy have clear reference to conformance with ILO standards? (1 point)
   d. Part 4:
      i. Does the company's human rights policy address the protection of indigenous peoples' rights? (1 point)
      ii. Does the company's human rights policy address the issue of child labor? (3 points)
      iii. Does the company's human rights policy address the issues of forced labor, prison labor, and/or indentured labor? (1 point)
      iv. Does the company make a commitment to the provision of competitive compensation and benefits to its workforce? (1 point)
      v.) Does the company's human rights policy address the protection of workers' rights? (1 point)
      vi. Does the company's human rights policy address the protection of women's rights? (1 point)
      vii. Does the company have a clearly stated policy regarding the employment of women? (1 point)
      viii. Does the company make a commitment to the provision of fair and equal wages to employees regardless of gender? (1 point)
      ix. Does the company's human rights policy address the protection of minority groups' rights? (1 point)
      x. Does the company have a clearly stated policy regarding the employment of minorities? (1 point)
   e. Part 5
      i. Evaluate Freedom House Country Scores for the worst level of country to which a company has exposure.
         1. If worst Freedom House score=14, (−12 points)
         2. If worst Freedom House score=13, (−9 points)
         3. If worst Freedom House score=12, (−6 points)
         4. If worst Freedom House score=11, (−3 points)
         5. If worst Freedom House score<11, (0 points)
   f. Sum Parts 1-5 as the raw human rights score.
5. Once the raw Human Rights Scores have been calculated, distribute these scores on a scale of 1 to 100 using the following formula for each company in the data set.

1+(([raw Human Rights Score]−[Minimum raw Human Rights Score in the dataset])*(100−1)/([Maximum raw Human Rights Score in the dataset]−[Minimum raw Human Rights Score in the dataset]))
6. Calculate Sector Scores.
   f. Each company in the dataset should be assigned to a unique industry or sector. For each sector in the universe, this system calculates a “sector score” which is a distribution from 1 to 100 of the raw human rights scores within each sector using the following formula:

1+(([raw Human Rights Score]−[Minimum raw Human Rights Score in the sector dataset])*(100−1)/([Maximum raw Human Rights Score in the sector dataset]−[Minimum raw Human Rights Score in the sector dataset]))
7. Calculate the Final Human Rights Score using the following formula that combines the Human Rights Score (Step 5) with Sector Score (Step 6):

([Human Rights Score (Step 5)]+[Sector Score (Step 6)])/2
8. Calculate Workforce Attributes score based on the attributes list in #2 above, assigning the following points:
   a. Part 1:
      i. What is the degree of disclosure by the company regarding the benefits it offers its employees Detailed, Limited, or None? (5 points for “detailed” or 3 points for “limited”)
      ii. Does the company make a commitment to the provision of fair and equal wages to employees regardless of gender? (1 point)
      iii. Does the company itself disclose that it has been subject to organized labor actions, including strikes, at any of its U.S. or non U.S. locations involving at least 100 employees and lasting at least 21 calendar days within the last 12 months? (1 point)
      iv. Does the company disclose the composition of its workforce by employment status? (1 point)
      v. Does the company disclose information regarding employee-turnover rate? (1 point)
      vi. Does the company disclose the number of employee deaths? (1 point)
   b. Part 2:
      i. Does the company disclose how many hours of training each existing employee receives per year? (1 point)
      ii. Does the company disclose how many hours of safety training employees receive within a year? (1 point)
      iii. Does the company disclose the presence of any other training programs it provides to its employees? (1 point)
      iv. Does the company disclose the presence of any safety training programs for employees? (1 point)
      v. Has the company been fined or disciplined by the Equal Employment Opportunity Commission (EEOC) in the past 3 years? (−3 points)
      vi. Has the company been subject to organized labor actions, including strikes, at any of its U.S. locations involving at least 100 employees and lasting at least 21 calendar days within the last 12 months? (−3 points)
      vii. Does the company include information concerning employee training in its EHS/CSR report? (1 point)
      viii. Does the company have an enterprise level workforce policy? (10 points)
   c. Part 3:
      i. Do the same workforce policy standards apply to franchisees? (1 point)
      ii. Does the company's workforce policy specifically reference areas of challenge for the company and its industry? (1 point)
      iii. Does the company disclose third party involvement in the development of these policies? (1 point)
      iv. Does the company disclose the number of personnel involved in the implementation of these policies? (1 point)
      v. Does the company have a department or staff dedicated to the implementation of any of these policies? (1 point)
      vi. Is the Board of Directors specifically mentioned as having responsibility for any of the policies? (1 point)
      vii. Do any of the policies include a commitment to third-party auditing? (1 point)
      viii. Do any of the policies include a commitment to public reporting? (5 points)
      ix. Is there a commitment to stakeholder involvement in the policies? (1 point)
      x. Is the company's workforce policy a global workforce policy (other than saying the workforce policy is to comply with local laws)? (2 points)
   d. Workforce Step 1: [Part 1]+[part 2]+[PART 3]
9. Once the Workforce Scores have been calculated, distribute these scores on a scale of 1 to 100 using the following formula for each company in the data set.

1+(([Workforce Score]−[Minimum Workforce Score in the dataset])*(100−1)/([Maximum Workforce Score in the dataset]−[Minimum Workforce Score in the dataset]))
10. Calculate Sector Scores.
   g. Each company in the dataset should be assigned to a unique industry or sector. For each sector in the universe, this system calculates a “sector score” which is a distribution from 1 to 100 of the Workforce scores within each sector using the following formula:

1+(([Workforce Score]−[Minimum Workforce Score in the sector dataset])*(100−1)/([Maximum Workforce Score in the sector dataset]−[Minimum Workforce Score in the sector dataset]))
11. Calculate the Final Workforce Score using the following formula that combines the Workforce Score (Step 9) with Sector Score (Step 10):

([Workforce Score (Step 9)]+[Sector Score (Step 10)])/2
12. Calculate a raw score based on the attributes data list in #3 above, assigning points as follows:
   a. Does the company have a clearly stated policy regarding the protection of minority groups' rights? (1 point)
   b. Does the company disclose the percentage of new hires that is considered to be a member of a minority group? (1 point)
   c. Does the company have a clearly stated policy regarding the use of suppliers that are female- or minority-owned? (1 point)
   d. Does the company have a clearly stated policy regarding the protection of women's rights? (1 point)
   e. Does the company disclose the percentage of new hires that is female? (1 point)
   f. Does the company disclose the composition of its workforce by location? (1 point)
   g. Does the company provide any workforce demographic disclosure by age? (1 point)
   h. Does the company provide any workforce demographic disclosure by ethnicity? (1 point)
   i. Does the company provide any workforce demographic disclosure by race? (1 point)
   j. Does the company provide any workforce demographic disclosure by gender? (1 point)
   k. Does the company provide any demographic disclosure (limited to gender, race, ethnicity, age, and similar categories) regarding the composition of its workforce? (1 point)
13. Calculate Diversity Performance by assigning points based on the following formulas using data in #3 above.
   a. Part 2:
      i. [What is the percentage of the company's management force that considered to be a member of a minority group?]−[What is the percentage of the company's workforce that is considered to be a member of a minority group?] (if this value is less than 0, assign 0 points. If the value is greater than 0, assign that number of points.)
   b. Part 3:
      i. Calculate 10% of [What is the percentage of the company's management force that considered to be a member of a minority group?] (assign this number of points)
   c. Part 4:
      i. Calculate 20% of [What is the percentage of the company's workforce that is considered to be a member of a minority group?] (assign this number of points)
   d. Part 5:
      i. [What is the percentage of the company's management force that is female? ]−[What is the percentage of the company's workforce that is female? ] (if this value is less than 0, assign 0 points. If the value is greater than 0, assign that number of points.)
   e. Part 6:
      i. Calculate 10% of [What is the percentage of the company's management force that is female? ] (assign this number of points)
   f. Part 7:
      i. Calculate 20% of [What is the percentage of the company's workforce that is female? ] (assign this number of points)
14. Combined Diversity Score: [Diversity Attributes Score]+[Diversity Performance Score]
15. Once the Combined Diversity Scores have been calculated, distribute these scores on a scale of 1 to 100 using the following formula for each company in the data set.

1+(([Combined Diversity Scores]−[Minimum Combined Diversity Scores in the dataset])*(100−1)/([Maximum Combined Diversity Scores in the dataset]−[Minimum Combined Diversity Scores in the dataset]))
16. Calculate Sector Scores.
   h. Each company in the dataset should be assigned to a unique industry or sector. For each sector in the universe, this system calculates a “sector score” which is a distribution from 1 to 100 of the Combined Diversity Scores within each sector using the following formula:

1+(([Combined Diversity Scores]−[Minimum Combined Diversity Scores in the sector dataset])*(100−1)/([Maximum Combined Diversity Scores in the sector dataset]−[Minimum Combined Diversity Scores in the sector dataset]))
17. Calculate the Final Diversity Scores using the following formula that combines the Normalized Diversity Score (Step 15) with Sector Score (Step 16):

([Normalized Diversity Score (Step 15)]+[Sector Score (Step 16)])/2
18. Calculate and Combined Human Rights and Labor Score using the following formula:

([Final Human Rights Score (Step 7)]*0.5)+([Final Workforce Score (Step 11)]*0.25)+([Final Diversity Score (Step 17)]*0.25)
19. Once the Combined Human Rights and Labor Scores have been calculated, distribute these scores on a scale of 1 to 100 using the following formula for each company in the data set.

1+(([Combined Human Rights and Labor Scores]−[Minimum Combined Human Rights and Labor Scores in the dataset])*(100−1)/([Maximum Combined Human Rights and Labor Scores in the dataset]−[Minimum Combined Human Rights and Labor Scores in the dataset]))
20. Calculate Sector Scores.
   i. Each company in the dataset should be assigned to a unique industry or sector. For each sector in the universe, this system calculates a “sector score” which is a distribution from 1 to 100 of the Combined Diversity Scores within each sector using the following formula:

1+(([Combined Human Rights and Labor Scores]−[Minimum Combined Human Rights and Labor Scores in the dataset])*(100−1)/([Maximum Combined Human Rights and Labor Scores in the dataset]−[Minimum Combined Human Rights and Labor Scores in the dataset]))
21. Calculate the Final Human Rights and Labor Scores using the following formula that combines the Normalized Human Rights and Labor Score (Step 19) with Sector Score (Step 20):

([Normalized Human Rights and Labor Score (Step 19)]+[Sector Score (Step 20)])/2

Section 3: Other Applications

In addition to the ESG scoring and ratings of mutual funds, the system can be used in other ways.
1. Exchange Traded Funds (ETFs): While an ETF has different trading and management characteristics than a mutual fund, it is still a group of securities to which this document can be applied. For a full description, read Sections 1-2.7 above and replace “mutual fund” with “ETF”.
2. ESG Index: As established, the system can be applied to any basket of securities, specifically in this case to a “stock market index.” Since many of the calculations are “weighted average” calculations, and since a stock market index (i.e. the S&P 500 or the Dow) change value on a daily basis, an ESG Index would track the change in weighted ESG scores on a daily (or weekly, monthly, or quarterly) basis. As “better” ESG scoring companies change in value (and weighting) in the index and as “worse” ESG scoring companies change in value (and weighting) in the index, the reader of the index would see whether the market is being weighted more toward “better” ESG companies or “worse” ESG companies compared to the previous measurement.
   a. Process for calculating the ESG Index
      i. At each interval to be tracked by the index, use Section 1 above to calculate the weighted average ESG score of the index basket of securities.
      ii. Track and display the time series of these results.
3. Customized Weightings within ESG Scoring:
   a. Description: Sections 2.2-2.7 outline the methodology for calculating Category Scores, each as sub components of a comprehensive ESG score. The Section 2 introduction outlines the fixed weightings of each category score in generating the overall ESG score. Users may also control the weighting of these categories relative to one another.
      i. Example: While the current formula set forth in Section 2 provides for these weightings:
         CEO Compensation Category Score 11%
         Climate Change Category Score 11%
         Community Category Score 11%
         Environment Category Score 22%
         Governance Category Score 22%
         Human Rights and Labor Category Score 22%
      A user might prefer the following weightings:
         CEO Compensation Category Score 0%
         Climate Change Category Score 0%
         Community Category Score 0%
         Environment Category Score 50%
         Governance Category Score 0%
         Human Rights and Labor Category Score 50%
      Or the following:
         CEO Compensation Category Score 0%
         Climate Change Category Score 75%
         Community Category Score 0%
         Environment Category Score 25%
         Governance Category Score 0%
         Human Rights and Labor Category Score 0%
      Or any other combination totaling 100%
4. Calculate a Mutual Fund ESG Index: Create an index that represents the market (or sub market) of mutual fund investments. This would be an asset weighted calculation. As described elsewhere, the ESG calculation would be a weighted average once the index was assigned and calculated

### Hardware and Software

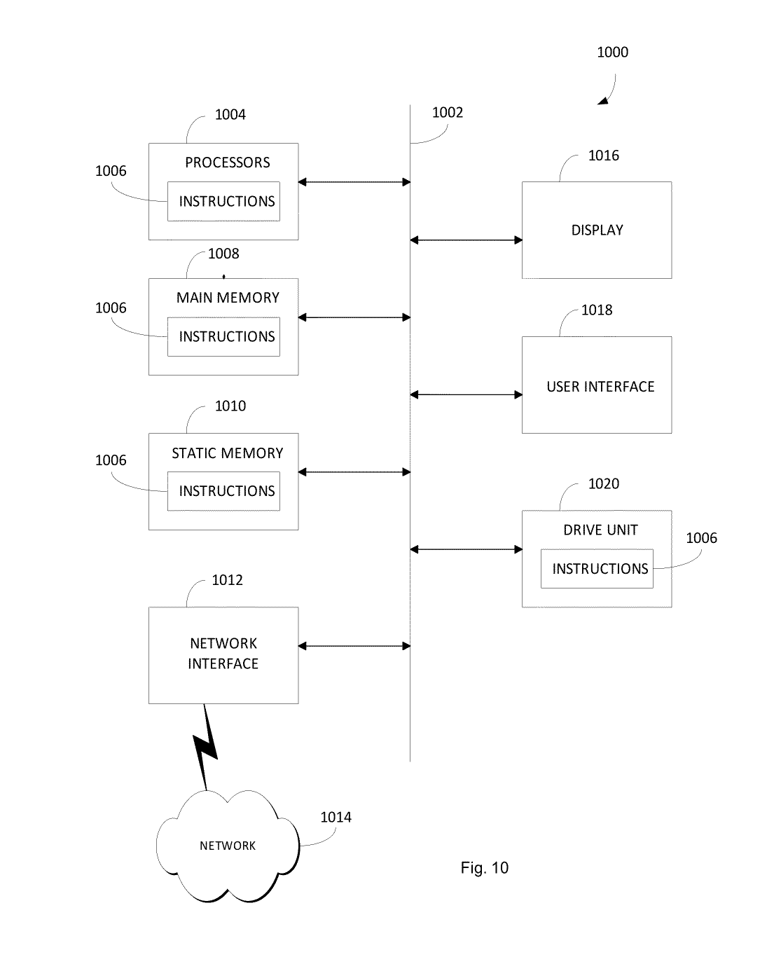

FIG. 10 shows a computing device 1000 that may be used for generating ESG Ratings and performing any combination of the operations, processes, or algorithms discussed above. The processing and/or computing devices described in this application include a storage media configured to generate and store unique environment, social, and governance (ESG) data and includes an interface configured to uniquely receive and transmit the ESG data.

The computing device 1000 may operate in the capacity of a server or a client machine in a server-client network environment, or as a peer machine in a peer-to-peer (or distributed) network environment. In other examples, computing device 1000 may be a personal computer (PC), a tablet, a Personal Digital Assistant (PDA), a cellular telephone, a smart phone, a web appliance, or any other machine or device capable of executing instructions 1006 (sequential or otherwise) that specify actions to be taken by that machine.

While only a single computing device 1000 is shown, the computing device 1000 may include any collection of devices or circuitry that individually or jointly execute a set (or multiple sets) of instructions to perform any one or more of the operations discussed above. Computing device 1000 may be part of an integrated control system or system manager, or may be provided as a portable electronic device configured to interface with a networked system either locally or remotely via wireless transmission.

Processors 1004 may comprise a central processing unit (CPU), a graphics processing unit (GPU), programmable logic devices, dedicated processor systems, micro controllers, or microprocessors that may perform some or all of the operations described above. Processors 1004 may also include, but may not be limited to, an analog processor, a digital processor, a microprocessor, multi-core processor, processor array, network processor, etc.

Some of the operations described above may be implemented in software and other operations may be implemented in hardware. One or more of the operations, processes, or methods described herein may be performed by an apparatus, device, or system similar to those as described herein and with reference to the illustrated figures.

Processors 1004 may execute instructions or “code” 1006 stored in any one of memories 1008, 1010, or 1020. The memories may store data as well. Instructions 1006 and data can also be transmitted or received over a network 1014 via a network interface device 1012 utilizing any one of a number of well-known transfer protocols.

Memories 1008, 1010, and 1020 may be integrated together with processing device 1000, for example RAM or FLASH memory disposed within an integrated circuit microprocessor or the like. In other examples, the memory may comprise an independent device, such as an external disk drive, storage array, or any other storage devices used in database systems. The memory and processing devices may be operatively coupled together, or in communication with each other, for example by an I/O port, network connection, etc. such that the processing device may read a file stored on the memory.

In one example, a computer program 1006 is stored on a tangible medium operating in processor 1004. Processor 1004 and memories 1008, 1010, and 1020 may be located a database system 1000. Computer program 1006 may comprise a set of instructions operable to download, by the database system, fund data identifying companies within a fund and proportions of the fund made up by the companies. The database system 1000 downloads environmental, social and governance (ESG) data associated with the companies and creates a relational database associating the ESG data with the companies identified in the fund data. The database system 1000 calculates company ESG scores based on the ESG data associated with the companies and weights the company ESG scores based on the proportions of the fund made up by the companies. The database system 1000 then calculates a fund ESG score for the fund based on the weighted ESG scores for the companies. Other operations performed by the database system are described throughout the specification and claims.

Some memory may be “read only” by design (ROM) by virtue of permission settings, or not. Other examples of memory may include, but may be not limited to, WORM, EPROM, EEPROM, FLASH, etc. which may be implemented in solid state semiconductor devices. Other memories may comprise moving parts, such a conventional rotating disk drive. All such memories may be “machine-readable” in that they may be readable by a processing device.

“Computer-readable storage medium” (or alternatively, “machine-readable storage medium”) may include all of the foregoing types of memory, as well as new technologies that may arise in the future, as long as they may be capable of storing digital information in the nature of a computer program or other data, at least temporarily, in such a manner that the stored information may be “read” by an appropriate processing device. The term “computer-readable” may not be limited to the historical usage of “computer” to imply a complete mainframe, mini-computer, desktop, wireless device, or even a laptop computer. Rather, “computer-readable” may comprise storage medium that may be readable by a processor, processing device, or any computing system. Such media may be any available media that may be locally and/or remotely accessible by a computer or processor, and may include volatile and non-volatile media, and removable and non-removable media.

Computing device 1000 can further include a video display 1016, such as a liquid crystal display (LCD) or a cathode ray tube (CRT)) and a user interface 1018, such as a keyboard, mouse, touch screen, etc. All of the components of computing device 1000 may be connected together via a bus 1002 and/or network.

For the sake of convenience, operations may be described as various interconnected or coupled functional blocks or figures. However, there may be cases where these functional blocks or diagrams may be equivalently aggregated into a single logic device, program or operation with unclear boundaries.

Having described and illustrated the principles of a preferred embodiment, it should be apparent that the embodiments may be modified in arrangement and detail without departing from such principles. Claim is made to all modifications and variation coming within the spirit and scope of the following claims.

1. A computer program stored on a tangible medium in a database system, the computer program comprising a set of instructions operable to:
download, by the database system, fund data identifying companies within a fund and proportions of the fund made up by the companies;
download, by the database system, environmental, social and governance (ESG) data associated with the companies;
create, by the database system, a relational database associating the ESG data with the companies identified in the fund data;
calculate, by the database system, company ESG scores based on the ESG data associated with the companies;
weight, by the database system, the company ESG scores based on the proportions of the fund made up by the companies; and
calculate, by the database system, a fund ESG score for the fund based on the weighted ESG scores for the companies.

2. The computer program of claim 1, further comprising instructions operable to:
identify, by the database system, market capitalizations for the companies in the fund; and
calculate, by the database system, the proportions of the fund made up by the companies based on the market capitalizations for the companies.

3. The computer program of claim 1, further comprising instructions operable to:
identify, by the database system, a first category of environmental related data within the ESG data;
calculate, by the database system, environment category scores for the companies from the environmental related data;
identify, by the database system, a second category of social related data within the ESG data;
calculate, by the database system, social category scores for the companies from the social related data;
identify, by the database system, a third category of governance related data within the ESG data;
calculate, by the database system, governance category scores for the companies based on the governance related data; and
calculate the company ESG scores based on the environment category scores, social category scores, and governance category scores associated with the companies.

4. The computer program of claim 3, further comprising instructions operable to:
identify, by the database system, amounts of greenhouse gas (GHG) emissions for the companies from the ESG data;
identify, by the database system, amounts of environmental fines for the companies from the ESG data;
identify, by the database system, amounts of oil and chemical spills for the companies from the ESG data; and
calculate, by the database system, the environment category scores for the companies based on the amounts of GHG emissions, environmental fines, and numbers of oil and chemical spills for the companies.

5. The computer program of claim 3, further comprising instructions operable to:
identify, by the database system, community information for the companies within the ESG data;
identify, by the database system, human rights and labor information for the companies within the ESG data; and
calculate, by the database system, the social category scores for the companies based on the community information, and human rights and labor information for the companies.

6. The computer program of claim 5, further comprising instructions operable to:
identify, by the database system, within the human rights and labor information a percentage of minorities and women employed by the companies;
identify, by the database system, within the human rights and labor information a percentage of the minorities and women in senior management positions for the companies; and
calculate, by the database system, the social category scores for the companies based on the percentage of minorities and women employed by the companies and the percentage of the minorities and women in senior management positions for the companies.

7. The computer program of claim 3, further comprising instructions operable to:
identify, by the database system, chief executive officer (CEO) compensation information for the companies within the ESG data; and
identify, by the database system, governance information for the companies within the ESG data; and
calculate, by the database system, the governance category scores for the companies based on the CEO compensation information and governance information for the companies.

8. The computer program of claim 3, further comprising instructions operable to:
identify, by the database system, in the ESG data types of disclosures the companies provide related to the environmental related data, the social related data, and/or the governance related data; and
calculate, by the database system, the company ESG scores based on the types of disclosures the companies provide.

9. The computer program of claim 3, further comprising instructions operable to:
identify, by the database system, within the ESG data attributes of policies for companies on environmental topics, social topics, and/or the governance topics; and
calculate, by the database system, the company ESG scores based on the attributes of policies for the companies.

10. The computer program of claim 1, further comprising instructions operable to:
calculate, by the database system, preliminary ESG scores for the companies;
identify, by the database system, the companies within same business economic sectors;
normalize, by the database system, the preliminary ESG scores for the companies within the same business economic sectors; and
calculate, by the database system, the company ESG scores based on the normalized preliminary ESG scores for the companies.

11. The computer program of claim 10, further comprising instructions operable to:
normalize, by the database system, the preliminary ESG scores for all of the companies within all of the business economic sectors; and
calculate, by the database system, the company ESG scores based on the normalized preliminary ESG scores for the companies within the same economic sectors and the normalized preliminary ESG scores for all of the companies within all of the business economic sectors.

12. A database system, comprising:
a storage device configured to store environment, social, and governance (ESG) data for different companies; and
a processing device coupled to the storage device configured to generate rating scores within the database system, the memory device having instructions stored thereon that, in response to execution by the processing device, are operable to:
identify companies within an index;
identify the ESG data for the companies within the index;
calculate company ESG scores from the ESG data for the companies within the index;
weight the company ESG scores based on proportions of the index made up by the companies; and
calculate an index ESG score based on the weighted company ESG scores for the companies in the index.

13. The database system of claim 12, wherein the index comprises an exchange traded funds (ETF) index.

14. The database system of claim 12 wherein the index comprises multiple mutual funds each including different groups of the companies.

15. The database system of claim 12, wherein the instructions are further operable to:
identify market capitalizations for the companies in the index;
calculate the proportions of the index made up by the comprises based on the market capitalizations for the companies; and
weight the company ESG scores based on the portions of the index made up by the companies.

16. The database system of claim 13, wherein the instructions are further operable to:
periodically monitor and detect changes in the market capitalizations for the companies in the index and changes in the company ESG scores;
periodically update the company ESG scores based on the changes in the market capitalizations; and
periodically update the index ESG score based on the changes in the company ESG scores.

17. The database system of claim 12, wherein the instructions are further operable to:
identify a first category of environmental related data within the ESG data;
calculate environment category scores for the companies from the environmental related data;
identify a second category of social related data within the ESG data;
calculate social category scores for the companies from the social related data;
identify a third category of governance related data within the ESG data;
calculate governance category scores for the companies based on the governance related data; and
calculate the company ESG scores based on the environment category scores, social category scores, and governance category scores associated with the companies within the index.

18. The database system of claim 12, wherein the instructions are further operable to:
receive user selected weights for items within the first, second, and third category;
apply the weights to the ESG data within the first, second, and third category; and
calculate the company ESG scores based on the weights applied to the ESG data.

19. The database system of claim 12, wherein the instructions are further operable to:
compare the index ESG score with other index ESG scores for other groups of companies; and
rate the index ESG score based on the comparison with the other index ESG scores.

20. (canceled)
